(19) United States
(12) Patent Application Publication
(10) Pub. No.: US 2012/0015160 A1
(43) Pub. Date: Jan. 19, 2012

(54) PROCESS FOR PRODUCING POLYMER MEMBER AND POLYMER MEMBER

(75) Inventors: Yusuke Sugino, Ibaraki-shi (JP); Kunio Nagasaki, Ibaraki-shi (JP); Kohei Doi, Ibaraki-shi (JP)

(73) Assignee: NITTO DENKO CORPORATION, Ibaraki-shi, Osaka (JP)

(21) Appl. No.: 13/256,589

(22) PCT Filed: Mar. 12, 2010
(86) PCT No.: PCT/JP2010/054712

§ 371 Date: Sep. 14, 2011

(30) Foreign Application Priority Data
Mar. 17, 2009 (JP) 2009-063729

(51) Int. Cl. B32B 3/00; B05D 5/00; B05D 3/06

(52) U.S. Cl. 428/195.1; 427/508

(57) ABSTRACT

Provided is a polymer member that demands no volatile component such as solvent during production, in which distribution of its immiscible material is controlled.

The process for producing polymer member according to the present invention comprises forming a monomer-absorptive layer that can absorb a polymerizable monomer on both faces of an immiscible material-containing polymerizable composition layer containing a substance incompatible with the polymer obtained by polymerization of the polymerizable monomer and obtaining, by polymerization of the laminate, a polymer member having an unevenly distributed structure in which the immiscible material is not present at the interface between the immiscible material-containing polymerizable composition layer and the monomer-absorptive layers immediately after lamination.

### TECHNICAL FIELD

The present invention relates to a process for producing a polymer member having a structure in which an immiscible material is distributed unevenly and the polymer member having a structure in which the immiscible material is unevenly distributed.

### BACKGROUND ART

Composite base materials having a base material and a substance different from the base material unevenly formed therein are highly expected as base materials with new additional functions such as optical and electrical functions. Examples of such base materials include laminate base materials having an intermediate layer containing particles. Such a laminate base material having a particle-containing intermediate layer can be prepared, for example, by obtaining a fine particle-dispersed solution by dispersing fine particles in a solution of a polymer component used as binder in organic solvent, forming a fine particle layer (fine particle-containing layer) on the surface of the base material by coating the fine particle-dispersed solution on a base material and evaporating the solvent by drying under heat, and bonding the same base material onto the fine particle layer additionally by some method. It is difficult to employ such a method, when the base material is soluble in the solvent or the base material has low heat resistance and melts or deforms in drying under heat, or to coat the fine particle-dispersed solution on the base material surface when the surface is highly tacky similarly to pressure-sensitive adhesive layers. The method is also unfavorable from the viewpoints of environment and energy conservation because solvents such as the solvent and water should be removed by drying. In addition, the base materials on top and bottom may exfoliate at the interface if the adhesiveness thereof is insufficient.

Further, although it is possible to form a fine particle layer on the surface of a base material sheet by forming a fine particle layer on a release-treated film and transferring the layer onto the base sheet, the base material layer and the fine particle layer are less adhesive to each other, possibly causing a problem of exfoliation between layers when the affinity or compatibility between the base material and the fine particle layer is low. Further when the base material and the fine particle layer are both hardly adhesive to each other, it is difficult to bond them to each other and needed to coat an adhesive on one or both of them before bonding.

The inventors have earlier found that, when an immiscible material-containing polymerizable composition layer, which contains a polymerizable monomer and an immiscible material that is immiscible with a polymer as a polymerization product of the polymerizable monomer, is formed at least on one side of a monomer-absorptive layer, the immiscible material migrates in the immiscible material-containing polymerizable composition layer to give a polymerizable composition layer containing an unevenly distributed immiscible material; that polymerization of the polymerizable composition layer containing an unevenly distributed immiscible material gives a multilayer structure of a monomer-absorptive layer and a polymer layer containing an unevenly distributed immiscible material; and that use of particles as the immiscible material in the multilayer structure of a monomer-absorptive layer and a polymer layer containing an unevenly distributed immiscible material gives, by the action of particles, a roughened surface on the surface of the polymer layer containing the unevenly distributed immiscible material, which is opposite to the interface with the monomer-absorptive layer (see Patent Document 1). On the basis on the invention, the inventors had proposed a polymer member having a multilayer structure having a polymer layer and a monomer-absorptive layer that can absorb at least one monomer component constituting the polymer, wherein the polymer layer is a polymer layer containing an unevenly distributed immiscible material that is immiscible with the polymer and is enriched at an interface, or in the vicinity thereof, opposite to the other interface with the monomer-absorptive layer.

However, the immiscible material is enriched at the interface or in the vicinity thereof, opposite to the other interface with the monomer-absorptive layer or in the region close to it, i.e., on one surface of the polymer member in this invention or vicinity thereof, and thus, it was not possible to obtain a polymer member in which it is distributed therein. In addition when an additional layer is formed on the surface of the polymer member of the invention, there is always an interface formed between the polymer member and the additional layer, prohibiting integration thereof and thus, possibly causing exfoliation of the newly formed layer.

### CITATION LIST

### Patent Literature

Patent Document 1: Japanese Unexamined Patent Application No.2008-006817

### SUMMARY OF INVENTION

### Technical Problem

Accordingly, an object of the present invention is to provide a polymer member that demands no volatile components such as solvents during production, in which distribution of the immiscible material is controlled. In particular, it is to provide a polymer member that demands no volatile components such as solvents during production, in which distribution of the immiscible material is controlled in a particular internal layer region.

### Solution to Problem

After intensive studies to solve the problems above, the inventors have found that it is possible to control distribution of the immiscible material in an internal certain layer region and obtain a polymer member having a structure in which the immiscible material is unevenly distributed, by forming a monomer-absorptive layer that can absorb a polymerizable monomer on both faces of an immiscible material-containing polymerizable composition layer containing a substance immiscible with the polymer obtained by polymerization of the polymerizable monomer and polymerizing the laminate, and made the present invention.

Thus, the present invention provides a process for producing a polymer member, comprising forming a monomer-absorptive layer that can absorb a polymerizable monomer on both faces of an immiscible material-containing polymerizable composition layer containing a substance immiscible with the polymer obtained by polymerization of the polymerizable monomer and giving, by polymerization of the laminate, a polymer member having an unevenly distributed structure in which the immiscible material is not present at the interface between the immiscible material-containing polymerizable composition layer and the monomer-absorptive layers immediately after lamination.

In addition, the present invention provides the process for producing a polymer member, wherein the monomer-absorptive layer is a polymeric monomer-absorptive polymer layer.

The present invention also provides the process for producing a polymer member, wherein at least one monomer component constituting the polymer in the monomer-absorptive polymer layer is identical with at least one of the polymerizable monomers constituting the immiscible material-containing polymerizable composition layer.

The present invention also provides the process for producing a polymer member, wherein the monomer-absorptive layer is a pressure-sensitive adhesive composition layer.

The present invention also provides the process for producing a polymer member, wherein active energy ray irradiation is used during the polymerization.

The present invention also provides the process for producing a polymer member, wherein the immiscible material is particles.

The present invention also provides the process for producing a polymer member, wherein the immiscible material is a polymer.

The present invention also provides the process for producing a polymer member, wherein the polymerizable monomer is an acrylic monomer.

The present invention also provides the process for producing a polymer member, wherein the polymer member is in shape of tape or sheet.

The present invention also provides a polymer member, characterized by being prepared by the process for producing a polymer member.

### Advantageous Effects of Invention

According to the process for producing polymer member according to the present invention, which has the configuration described above, it is possible to obtain a polymer member having a structure in which the immiscible material is distributed unevenly, in which distribution of the immiscible material is controlled in a particular internal layer region, without demand for using a volatile component such as solvent during production.

### BRIEF DESCRIPTION OF DRAWINGS

FIG. 1 is a scanning electron micrograph of the cross section of the polymer sheet of Example 1.

FIG. 2 is a scanning electron micrograph of the cross section of the region close to the particle-enriched region in the polymer sheet of Example 1.

FIG. 3 is a scanning electron micrograph of the cross section of the polymer sheet of Example 2.

FIG. 4 is a scanning electron micrograph of the cross section of the region close to the particle-enriched region in the polymer sheet of Example 2.

FIG. 5 is a scanning electron micrograph of the cross section of the polymer sheet of Example 3.

FIG. 6 is a scanning electron micrograph of the cross section of the region close to the particle-enriched region in the polymer sheet of Example 3.

FIG. 7 is a scanning electron micrograph of the cross section of the polymer sheet of Example 4.

FIG. 8 is a scanning electron micrograph of the cross section of the region close to the particle-enriched region in the polymer sheet of Example 4.

FIG. 9 is a scanning electron micrograph of the cross section of the polymer sheet of Example 5.

FIG. 10 is a scanning electron micrograph of the cross section of the region close to the particle-enriched region in the polymer sheet of Example 5.

FIG. 11 is a scanning electron micrograph of the cross section of the polymer sheet of Example 6.

FIG. 12 is a scanning electron micrograph of the cross section of the region close to the particle-enriched region in the polymer sheet of Example 6.

FIG. 13 is a scanning electron micrograph of the cross section of the polymer sheet of Example 7.

FIG. 14 is a scanning electron micrograph of the cross section of the region close to the particle-enriched region in the polymer sheet of Example 7.

FIG. 15 is a scanning electron micrograph of the cross section of the polymer sheet of Example 8.

FIG. 16 is a scanning electron micrograph of the cross section of the region close to the particle-enriched region in the polymer sheet of Example 8.

FIG. 17 is a scanning electron micrograph of the cross section of the polymer sheet of Example 9.

FIG. 18 is a scanning electron micrograph of the cross section of the region close to the particle-unevenly distributed region in the polymer sheet of Example 9.

FIG. 19 is an optical micrograph of the cross section of the polymer sheet of Example 10.

FIG. 20 is an optical micrograph of the cross section of the region close to the immiscible material-enriched region in the polymer sheet of Example 10.

FIG. 21 is an optical micrograph of the cross section of the polymer sheet of Example 11.

FIG. 22 is an optical micrograph of the cross section of the region close to the immiscible material-enriched region in the polymer sheet of Example 11.

FIG. 23 is a scanning electron micrograph of the cross section of the sheet of Comparative Example 1.

FIG. 24 is a scanning electron micrograph of the cross section of a region of the sheet of Comparative Example 1.

FIG. 25 is a scanning electron micrograph of the cross section of the sheet of Comparative Example 2.

FIG. 26 is a scanning electron micrograph of the cross section of a region of the sheet of Comparative Example 2.

FIG. 27 is a scanning electron micrograph of the cross section of the sheet of Comparative Example 3.

FIG. 28 is a scanning electron micrograph of the cross section of a region of the sheet of Comparative Example 3.

FIG. 29 is a scanning electron micrograph of the cross section of the sheet of Comparative Example 4.

FIG. 30 is a scanning electron micrograph of the cross section of the region close to the particle-enriched region in the sheet of Comparative Example 4.

FIG. 31 is a scanning electron micrograph of the cross section of the sheet of Comparative Example 5.

FIG. 32 is a scanning electron micrograph of the cross section of a region of the sheet of Comparative Example 5.

FIG. 33 is a scanning electron micrograph of the cross section of the sheet of Comparative Example 6.

FIG. 34 is a scanning electron micrograph of the cross section of a region of the sheet of Comparative Example 6.

FIG. 35 is a scanning electron micrograph of the cross section of the sheet of Comparative Example 7.

FIG. 36 is a scanning electron micrograph of the cross section of a region of the sheet of Comparative Example 7.

FIG. 37 is a scanning electron micrograph of the cross section of the sheet of Comparative Example 8.

FIG. 38 is a scanning electron micrograph of the cross section of a region of the sheet of Comparative Example 8.

FIG. 39 is a scanning electron micrograph of the cross section of the sheet of Comparative Example 9.

FIG. 40 is a scanning electron micrograph of the cross section of a region of the sheet of Comparative Example 9.

### DESCRIPTION OF EMBODIMENTS

### [Process for Producing Polymer Member]

The process for producing polymer member according to the present invention is characterized by comprising forming a monomer-absorptive layer that can absorb a polymerizable monomer on both faces of an immiscible material-containing polymerizable composition layer containing an immiscible material immiscible with the polymer obtained by polymerization of the polymerizable monomer and giving, by polymerization of the laminate, a polymer member having an unevenly distributed structure in which the immiscible material is not present at the interface between the immiscible material-containing polymerizable composition layer and the monomer-absorptive layers immediately after lamination.

Lamination of the monomer-absorptive layer on both faces of the immiscible material-containing polymerizable composition layer gives a laminate having a structure of monomer-absorptive layer/immiscible material-containing polymerizable composition layer/monomer-absorptive layer (hereinafter, referred to as a “particular laminate”). Specifically, the process for producing polymer member according to the present invention may be characterized by forming a laminate having a configuration of a monomer-absorptive layer, an immiscible material-containing polymerizable composition layer laminated on the monomer-absorptive layer, and a monomer-absorptive layer laminated additionally on the immiscible material-containing polymerizable composition layer and giving, by polymerization thereof, a laminate having an unevenly distributed structure in which the immiscible material is not present at the interface between the immiscible material-containing polymerizable composition layer and the monomer-absorptive layers immediately after lamination.

The particular laminate can be prepared, for example, by obtaining an immiscible material-containing polymerizable composition layer by coating an immiscible material-containing polymerizable composition on a monomer-absorptive layer and laminating a monomer-absorptive layer additionally on the immiscible material-containing polymerizable composition layer, or by forming an immiscible material-containing polymerizable composition layer by coating the an immiscible material-containing polymerizable composition on a suitable substrate, transferring the immiscible material-containing polymerizable composition layer onto a monomer-absorptive layer, and additionally laminating a monomer-absorptive layer on the transferred immiscible material-containing polymerizable composition layer. In the present application, the face provided by the monomer-absorptive layer may be referred to as a monomer-absorptive surface.

In coating of the immiscible material-containing polymerizable composition, for example, a common coater (such as comma roll coater, die roll coater, gravure roll coater, reverse roll coater, kiss roll coater, dip roll coater, bar coater, knife coater or spray coater) may be used.

In the process for producing polymer member according to the present invention, a polymer member having an unevenly distributed structure in which the immiscible material is not present at the interface between the immiscible material-containing polymerizable composition layer and the monomer-absorptive layer immediately after lamination and distribution of the immiscible material is controlled in an internal certain layer region is prepared, because of the following reasons (i) to (iii);

(i) when the immiscible material-containing polymerizable composition layer is formed in contact with the monomer-absorptive layers, the polymerizable monomer in the immiscible material-containing polymerizable composition layer is absorbed into the monomer-absorptive layers;

(ii) when the monomer-absorptive layer is formed on both faces of the immiscible material-containing polymerizable composition layer, the immiscible material migrates in the immiscible material-containing polymerizable composition layer and the immiscible material is enriched in the central region in the layer thickness direction, and thus giving an unevenly distributed structure in which the immiscible material is not present at the interface between the immiscible material-containing polymerizable composition layer and the monomer-absorptive layers immediately after lamination; and

(iii) irradiation of active energy ray or heat leads to initiation of polymerization and curing of the resulting polymer, as the unevenly distributed structure of (ii) is preserved, finally giving a polymer member.

The polymerization is not particularly limited in light source or source, irradiation or heat energy, irradiation or heating method, exposure or heating time, initiation and termination time of irradiation or heating and others, if the polymer member is produced by polymerization and curing.

Examples of the active energy rays used during polymerization include ionizing radioactive rays such as α-ray, β-rays, γ-ray, neutron beam and electron beam, ultraviolet ray and the like, and in particular, ultraviolet ray is favorable. The irradiation energy, exposure period, irradiation method and others of the active energy ray is not particularly limited, if the polymer member is formed.

The active energy ray irradiation is, for example, ultraviolet irradiation by using a black light lamp, chemical lamp, high-pressure mercury lamp, metal halide lamp or the like.

Alternatively, heating can be performed, for example, by a known heating method (for example, heating by using an electric heater or by using an electromagnetic wave such as infrared ray).

(Immiscible Material-Containing Polymerizable Composition Layer (Particle-Containing Polymerizable Composition Layer))

The immiscible material-containing polymerizable composition layer is a layer formed with an immiscible material-containing polymerizable composition. The immiscible material-containing polymerizable composition is a composition forming the immiscible material-containing polymerizable composition layer that contains at least a polymerizable monomer that is polymerized by light or heat and an immiscible material. The immiscible material-containing polymerizable composition may be a particle-containing polymerizable composition containing particles of an immiscible material or an immiscible material-containing photopolymerizable composition containing a photopolymerization initiator as the polymerization initiator. For example, the immiscible material-containing polymerizable composition may be a particle-containing photopolymerizable composition containing the particles as an immiscible material and additionally a photopolymerization initiator as the polymerization initiator.

It is important that the polymerizable monomer is a compound that is polymerized by light or heat energy, independently of the reaction mechanism: radical polymerization, cationic polymerization or the like. Examples of the polymerizable monomers include radical polymerizable monomers such as acrylic monomers forming acrylic polymers; cation polymerizable monomers such as epoxy-based monomers forming epoxy resins, oxetane-based monomers forming oxetane resins, and vinyl ether-based monomers forming vinyl ether resins; combinations of a polyisocyanate and a polyol forming urethane resins; combinations of a polycarboxylic acid and a polyol forming polyester resins and the like. The polymerizable monomers may be used alone or in combination of two or more.

Acrylic monomers, which are higher in polymerization rate and superior in productivity, are used favorably as the polymerizable monomers. Thus, an acrylic polymer member is preferable in the present invention.

Since an acrylic monomer is used favorably as the polymerizable monomer in the present invention as described above, the immiscible material-containing polymerizable composition (particle-containing polymerizable composition) is preferably an immiscible material-containing acrylic polymerizable composition (particle-containing acrylic polymerizable composition).

Alkyl (meth)acrylate esters having an alkyl group are used favorably as the acrylic monomers. In particular, alkyl (meth)acrylate esters having an alkyl group having 2 to 14 carbon atoms are preferable, and alkyl (meth)acrylate ester having an alkyl group having 2 to 10 carbon atoms are more preferable. The term “(meth)acryl” means “acryl” and/or “methacryl,” and the same applies to other similar terms.

The alkyl (meth)acrylate esters having an alkyl group favorably used include both alkyl (meth)acrylate esters having a straight-chain or branched linear alkyl group and alkyl (meth)acrylate esters having a cyclic alkyl group.

Examples of the alkyl (meth)acrylate esters having a straight-chain or branched linear alkyl group include alkyl (meth)acrylate esters having an alkyl group having 1 to 20 carbon atoms such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate.

Examples of the alkyl (meth)acrylate esters having a cyclic alkyl group include cyclopentyl (meth)acrylate, cyclohexyl (meth)acrylate, isobornyl (meth)acrylate and the like.

The acrylic monomers may be used alone or in combination of two or more. When an acrylic polymer member is prepared, the acrylic monomer is used in the immiscible material-containing polymerizable composition preferably in an amount of 60 wt % or more, more preferably 80 wt % or more with respect to the total amount of the polymerizable monomers.

Various copolymerizable monomers such as polar group-containing monomers and polyfunctional monomers may be used as the polymerizable monomers in the immiscible material-containing polymerizable composition. For example, addition of a copolymerizable monomer to the immiscible material-containing acrylic polymerizable composition leads to improvement in cohesive power. The copolymerizable monomers may be used alone or in combination of two or more.

Examples of the polar group-containing monomers include carboxyl group-containing monomers such as (meth)acrylic acid, itaconic acid, maleic acid, fumaric acid, crotonic acid, and isocrotonic acid, or the anhydride thereof (such as maleic anhydride); hydroxyl group-containing monomers including hydroxyalkyl (meth)acrylates such as hydroxyethyl (meth)acrylate, hydroxypropyl (meth)acrylate, and hydroxybutyl (meth)acrylate, vinylalcohol, and allyl alcohol; amide group-containing monomers such as (meth) acrylamide, N,N-dimethyl(meth)acrylamide, N-methylol (meth) acrylamide, N-methoxymethyl(meth)acrylamide, and N-butoxymethyl(meth)acrylamide; amino group-containing monomers such as aminoethyl (meth)acrylate, diethylaminoethyl (meth)acrylate, and t-butylaminoethyl (meth)acrylate; glycidyl group-containing monomers such as glycidyl (meth)acrylate and methylglycidyl (meth)acrylate; cyano group-containing monomers such as acrylonitrile and methacrylonitrile; heterocyclic ring-containing vinyl monomers such as N-vinyl-2-pyrrolidone, (meth) acryloylmorpholine, N-vinylpyridine, N-vinylpiperidone, N-vinylpyrimidine, N-vinylpiperazine, N-vinylpyrrole, N-vinylimidazole, and N-vinyloxazole; alkoxyalkyl (meth)acrylate-based monomers such as methoxyethyl (meth)acrylate and ethoxyethyl (meth)acrylate; sulfonic acid group-containing monomers such as sodium vinylsulfonate; phosphate group-containing monomers such as 2-hydroxyethyl acryloyl phosphate; imide group-containing monomers such as cyclohexylmaleimide and isopropylmaleimide; isocyanate group-containing monomers such as 2-methacryloyloxyethyl isocyanate and the like. Among the compounds above, the polar group-containing monomer is preferably a carboxyl group-containing monomer or the anhydride thereof, and particularly preferably acrylic acid.

The amount of the polar group-containing monomer used may be altered properly in accordance with the purpose and application of the polymer member obtained but, for example, in the case of the immiscible material-containing acrylic polymerizable composition, it is preferably 30 wt % or less (e.g., 1 to 30 wt %), more preferably 3 to 20 wt %, with respect to the total amount of the polymerizable monomers. A polar group-containing monomer rate of more than 30 wt % may lead to excessive increase of the cohesive power of the polymer obtained, causing nonconformity, for example, in flexibility. Alternatively, an excessively low content of the polymerizable monomer (less than 1 wt % with respect to the total amount of the polymerizable monomers) may lead to decrease of the cohesive power of the polymer obtained, prohibiting high strength thereof.

Examples of the polyfunctional monomers include hexanediol di(meth)acrylate, butanediol di(meth)acrylate, (poly)ethylene glycol di(meth)acrylate, (poly)propylene glycol di(meth)acrylate, neopentylglycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylates, polyester acrylates, urethane acrylates and the like.

The amount of the polyfunctional monomer used may be altered properly in accordance with the purpose and application of the polymer member obtained, but is, for example, in the case of the immiscible material-containing acrylic polymerizable composition, it is preferably 2 wt % or less (for example, 0.01 to 2 wt %), more preferably 0.02 to 1 wt %, with respect to the total amount of the polymerizable monomers. When the amount of the polyfunctional monomer used is more than 2 wt % with respect to the total amount of the polymerizable monomers, the polymer obtained may have excessively high cohesive power and become excessively fragile. Alternatively, in the case of excessively small polymerizable monomer amount (less than 0.01 wt % with respect to the total amount of the polymerizable monomers), the polymer obtained may have decreased cohesive power and may not retain its shape.

Examples of copolymerizable monomers except the polar group-containing monomers and the polyfunctional monomers above include (meth)acrylic esters excluding alkyl (meth)acrylate ester, including aromatic hydrocarbon group-containing (meth)acrylic esters such as phenyl (meth)acrylate, polar group-containing monomers, and polyfunctional monomers; vinyl esters such as vinyl acetate and vinyl propionate; aromatic vinyl compounds such as styrene and vinyltoluene; olefin or dienes such as ethylene, butadiene, isoprene and isobutylene; vinyl ethers such as vinyl alkyl ethers; vinyl chloride and the like.

A polymerization initiator may be used, as needed, and for example, either a thermal polymerization initiator or a photopolymerization initiator (photoinitiator) may be used. In the present invention, a curing reaction caused by heat or active energy ray by using a polymerization initiator such as thermal polymerization initiator or photopolymerization initiator (photoinitiator) is preferably used during polymerization. According to the present invention, it is possible by using a polymerization initiator to cure the laminate easily, while the unevenly distributed structure in which the immiscible material is not present at the interface between the immiscible material-containing polymerizable composition layer and the monomer-absorptive layers immediately after lamination is retained.

The photopolymerization initiator is not particularly limited, and examples thereof for use include benzoin ether-based photopolymerization initiators, acetophenone-based photopolymerization initiators, a-ketol-based photopolymerization initiators, aromatic sulfonyl chloride-based photopolymerization initiators, optically active oxime-based photopolymerization initiators, benzoin-based photopolymerization initiators, benzyl-based photopolymerization initiators, benzophenone-based photopolymerization initiators, ketal-based photopolymerization initiators, thioxanthone-based photopolymerization initiators and the like. The photopolymerization initiators may be used alone or in combination of two or more.

Specifically, the ketal-based photopolymerization initiators include, for example, 2,2-dimethoxy-1,2-diphenylethan-1-one [for example, “Irgacure 651,” (trade name, manufactured by Ciba Specialty Chemicals Corporation Corporation)], and the like. Examples of the acetophenone-based photopolymerization initiators include 1-hydroxycyclohexylphenylketone [e.g., “Irgacure 184” (trade name, manufactured by Ciba Specialty Chemicals Corporation), etc.], 2,2-diethoxyacetophenone, 2,2-dimethoxy-2-phenylacetophenone, 4-phenoxydichloroacetophenone, 4-(t-butyl)dichloroacetophenone and the like. Examples of the benzoin ether-based photopolymerization initiators include benzoin methyl ether, benzoin ethyl ether, benzoin propyl ether, benzoin isopropyl ether, benzoin isobutyl ether and the like. Examples of the acylphosphine oxide-based photopolymerization initiators for use include “Lucirin TPO” (trade name, manufactured by BASF Japan Ltd.) and the like. Examples of the α-ketol-based photopolymerization initiators include 2-methyl-2-hydroxypropiophenone, 1-[4-(2-hydroxyethyl)phenyl]-2-methylpropan-1-one and the like. Examples of the aromatic sulfonyl chloride-based photopolymerization initiators include 2-naphthalene sulfonyl chloride and the like. Examples of the optically active oxime-based photopolymerization initiators include 1-phenyl-1,1-propandione-2-(o-ethoxycarbonyl)-oxime and the like. Examples of the benzoin-based photopolymerization initiators include benzoin and the like. Examples of the benzyl-based photopolymerization initiators include benzyl and the like. Examples of the benzophenone-based photopolymerization initiators include benzophenone, benzoylbenzoic acid, 3,3′-dimethyl-4-methoxybenzophenone, polyvinylbenzophenone, α-hydroxycyclohexylphenylketone and the like. Examples of the thioxanthone-based photopolymerization initiators include thioxanthone, 2-chlorothioxanthone, 2-methylthioxanthone, 2,4-dimethylthioxanthone, isopropylthioxanthone, 2,4-diisopropylthioxanthone, dodecylthioxanthone and the like.

The amount of the photopolymerization initiator used is not particularly limited but, for example, selected in the range of 0.01 to 5 parts by weight (preferably 0.05 to 3 parts by weight) with respect to 100 parts by weight of all polymerizable monomers constituting the immiscible material-containing polymerizable composition.

Examples of the thermal polymerization initiators include azo-based polymerization initiators [e.g., 2,2′-azobisisobutylonitrile, 2,2′-azobis-2-methylbutylonitrile, 2,2′-dimethyl azobis(2-methylpropionate), 4,4′-azobis-4-cyanovaleric acid, azobisisovaleronitrile, 2,2′-azobis(2-amidinopropane)dihydrochloride, and 2,2′-azobis[2-(5-methyl-2-imidazolin-2-yl)propane]dihydrochloride, 2,2′-azobis(2-methylpropionamidine)disulfate salt, 2,2′-azobis(N,N′-dimethyleneisobutylamidine)dihydrochloride], peroxide-based polymerization initiators (e.g., dibenzoyl peroxide, tert-butyl permaleate), redox-based polymerization initiators (e.g., combinations of organic peroxide/vanadium compound; organic peroxide/dimethylaniline; and metal naphthenate salt/butyl aldehyde, aniline, acetylbutylolactone) and the like. The amount of the thermal polymerization initiator used is not particularly limited, if it is in the range that it is effective as the thermal polymerization initiator. When a redox-based polymerization initiator is used as the thermal polymerization initiator, it is possible to cause polymerization at room temperature.

The immiscible material is not particularly limited, if it is a substance immiscible (insoluble) with the polymer obtained by polymerization of the polymerizable monomer, and may be an inorganic material (inorganic substance) or an organic material (organic substance). In addition, the immiscible material may be solid or liquid.

Example of the inorganic substances as the immiscible materials include, for example, the following particles (fine particles, fine particles powder). Alternatively, examples of the organic materials as the immiscible materials include polymers and oligomers of acrylic polymers, polyesters, polyurethanes, polyethers, silicones, natural rubbers, synthetic rubbers [in particular, styrene component-containing synthetic rubbers such as styrene-isoprene-styrene rubber (SIS), styrene-butadiene-styrene rubber (SBS), and styrene-ethylene-butylene-styrene rubber (SEBS)]; tackifiers (adhesive resins) such as rosin-based adhesive resins, terpene-based adhesive resins, phenol-based adhesive resins, hydrocarbon-based adhesive resins, ketone-based adhesive resins, polyamide-based adhesive resins, epoxy-based adhesive resins, and elastomer-based adhesive resins; surfactants; antioxidants; organic pigments; plasticizers; liquids such as solvents (organic solvents) and the like. In addition, water and aqueous solutions (e.g., aqueous salt solutions, aqueous acid solutions) are also used as the immiscible materials.

It is possible to determine whether a substance is immiscible to a polymer, by examining the degree of dispersion of the substance or its aggregate thereof in the polymer, for example by means of visual observation, observation under optical microscope, scanning electron microscope (SEM) or transmission electron microscope (TEM) or X-ray analysis in accordance with a general method not dependent on the present invention (for example, by a method of dissolving a substance in the polymerizable monomers, producing a polymer by polymerization of the polymerizable monomers; dissolving the polymer in a solvent dissolving the polymer, adding a substance thereto and removing the solvent after agitation; or fusing a polymer under heat if the polymer is a thermoplastic polymer, adding a substance thereto and examining the degree of dispersion after cooling). The evaluation criterion then is a diameter of 5 nm or more when the substance or the aggregate thereof can be approximated as a spherical shape such as sphere, cube or undefined shape, and a length of the longest side of 10 nm or more when it can be approximated as a rod shape such as rod, thin layer or cuboid.

Typical methods of dispersing a substance or the aggregate thereof in a polymer include a method of adding and dispersing uniformly a polymerizable monomer constituting the polymer (100 parts by weight), a photopolymerization initiator (0.5 parts by weight), and a substance or the aggregate thereof (50 parts by weight), coating the mixture on a PET film to a thickness of about 10 to 500 μm, and polymerizing the layer by UV irradiation from a black light lamp, while the influence by oxygen is suppressed under an inert gas such as nitrogen or with a cover film; a method of preparing a polymer previously by any method such as solution polymerization or ultraviolet polymerization, dissolving the polymer in a solvent, adding a substance or the aggregate to the solvent system containing the polymer added thereto, in an amount equivalent to 50 parts by weight with respect to 100 parts by weight of the polymer, dispersing the mixture uniformly, coating the resulting mixture on PET and drying the wet film for removal of the solvent to give a dry film having a thickness of about 10 to 500 μm, and the like.

In dispersing a substance in polymer, it is possible to approximate a substance to be incompatible with the polymer, if the substance or the aggregate thereof can be approximated as a spherical shape such as sphere, cube or undefined shape in the polymer and the spherical substance or the aggregate thereof has a diameter of 5 nm or more, while it is possible to approximate a substance incompatible with the polymer, if the substance or the aggregate thereof can be approximated as a rod shaped such as rod, thin layer or cuboid and the length of the longest side of the rod-shaped substance or the aggregate thereof is 10 nm or more.

Examples of the particles used as the immiscible materials include inorganic particles such as of silica, silicone (silicone powder), calcium carbonate, clay, titanium oxide, talc, layered silicate salts, clay minerals, metal powders (e.g., nickel powder, aluminum powder, iron powder, magnesium powder, copper powder, powder), barium titanate, boron nitride, silicon nitride, aluminum nitride, glass, glass beads, glass balloons, alumina balloons, ceramic balloons, titanium white, and carbon black; organic particles such as polyester beads, nylon beads, silicone beads, urethane beads, vinylidene chloride beads, and acrylic balloons; resin particles such as crosslinked acryl particles, crosslinked styrene particles, melamine resin particles, benzoguanamine resins, and nylon resins; inorganic-organic hybrid particles and the like. The particles may be solid particles or hollow particles (balloons). In addition, the particles may be used alone or in combination of two or more.

The particle diameter (average particle diameter) of the particles is not particularly limited, but can be selected, for example, in the range of 0.1 to 600 μm (preferably 0.2 to 300 μm, more preferably 0.2 to 100 μm). In addition, the particles may be used in combination of two or more particles different in particle diameter.

The particles may be in any shape such as spherical shape (spherical or elliptical), undefined shape, spicular, rod shape or flat plate shape. The particles may have pores and projections on the surface. Particles in a single shape may be used as selected, or two or more particles different in shape may be used in combination.

The surface of the particles may be subjected to various surface treatments (e.g., surface tension-reducing treatment by using a silicone or fluorine compound).

The amount of the immiscible material used is not particularly limited but, for example, selected in the range of 0.001 to 100 parts by weight, preferably 0.01 to 75 parts by weight, more preferably 0.1 to 50 parts by weight, with respect to, 100 parts by weight of all polymerizable monomers constituting the immiscible material-containing polymerizable composition. An amount of more than 100 parts by weight may cause difficulty in preparation of the polymer member or problems of the strength of the polymer member obtained. When the amount used is less than 0.001 part by weight, it is difficult to obtain a polymer member having an unevenly distributed structure in which the immiscible material is not present at the interface between the immiscible material-containing polymerizable composition layer and the monomer-absorptive layers immediately after lamination therein.

In the present invention, the immiscible material in the polymer member is enriched in the layer shape in the region close to the center in the thickness direction. The thickness of the region (mainly distributed layered region above) in which such an immiscible material is distributed can be controlled by adjustment of the amount of the immiscible material used.

The immiscible material-containing polymerizable composition may contain suitable additives additionally, as needed. Examples of the additives include surfactants (e.g., ionic surfactants, silicone-based surfactants, fluorochemical surfactants), crosslinking agents (e.g., polyisocyanate-based crosslinking agents, silicone-based crosslinking agents, epoxy-based crosslinking agents, alkyl-etherified melamine-based crosslinking agents), tackifiers (e.g., those solid, semisolid or liquid at room temperature such as rosin-derived resins, polyterpene resins, petroleum resins, and oil-soluble phenol resins), plasticizers, fillers, aging inhibitors, antioxidants, colorants (pigments, dyes, etc.) and the like.

For example, pigments (coloring pigments) may be used in an amount that does not inhibit polymerization reaction such as photopolymerization reaction, from the viewpoints of design, optical properties and others. When the color is desirably black, carbon black may be used as the coloring pigment. The amount of the carbon black used is, for example, 0.15 part by weight or less (for example, 0.001 to 0.15 part by weight) with respect to 100 parts by weight of all polymerizable monomers constituting the immiscible material-containing polymerizable composition, from the viewpoints of intensity of the color and inhibition of the photopolymerization reaction.

The immiscible material-containing polymerizable composition can be prepared by mixing and dispersing the respective components uniformly. The immiscible material-containing polymerizable composition preferably has a viscosity suitable for coating operation because it is normally applied in the sheet shape, as it is coated on a base material. The viscosity of the immiscible material-containing polymerizable composition can be adjusted, for example, by blending various polymers such as acrylic rubbers, thickening additives and others or by polymerizing the polymerizable monomers in the immiscible material-containing polymerizable composition partially, for example, by photoirradiation or heating. The desired viscosity, as determined by using a BH viscometer with a No. 5 rotor under the condition of a rotational frequency of 10 rμm and a measurement temperature of 30° C., is 5 to 50 Pa·s, more preferably 10 to 40 Pa·s. A viscosity of less than 5 Pa·s leads to uncontrolled flow of the composition, when coated on a base material, while a viscosity of more than 50 Pa·s to difficulty of coating because of excessively high viscosity.

The thickness of the immiscible material-containing polymerizable composition layer is not particularly limited, but is preferably 99% or less, more preferably 75% or less, still more preferably 50% or less, with respect to the total thickness of the immiscible material-containing polymerizable composition layer and the monomer-absorptive layer. It is because the immiscible material is distributed unevenly in greater extent and the immiscible material can be incorporated in greater amount, when the thickness ratio of the immiscible material-containing polymerizable composition layer is smaller.

Specifically, the thickness of the immiscible material-containing polymerizable composition layer is, for example, 1 to 3000 μm, preferably 10 to 1000 μm and more preferably 50 to 500 μm. A thickness of less than 1 μm prohibit uniform coating. Alternatively, a thickness of more than 3000 μm may lead to generation of waviness, prohibiting production of a member uniform in surface shape and superior in appearance and to generation of waviness of a film, for example when the polymer member is molded into a film shape, prohibiting production of a smooth film.

### (Monomer-Absorptive Layer)

The monomer-absorptive layer is a layer that is formed on both faces of the immiscible material-containing polymerizable composition layer containing polymerizable monomers and an immiscible material and absorbs at least one of the polymerizable monomer from the immiscible material-containing polymerizable composition layer. Such a monomer-absorptive layer provides a monomer-absorptive surface that can absorb at least one monomer component in the immiscible material-containing polymerizable composition.

Absorption of the polymerizable monomers in the monomer-absorptive layer occurs when the immiscible material-containing polymerizable composition layer is formed on the monomer-absorptive surface. Alternatively, it may occur after preparation of the immiscible material-containing polymerizable composition layer and before or during polymerization.

A monomer-absorptive layer in a sheet in the configuration in which it has at least one monomer-absorptive layer and the monomer-absorptive surface of the monomer-absorptive layer is in contact with the immiscible material-containing polymerizable composition layer (hereinafter, referred to as “monomer-absorptive sheet”) may be used as the monomer-absorptive layer. Examples of the monomer-absorptive sheets include monomer-absorptive sheets having only a monomer-absorptive layer (hereinafter, referred to as “base material-less monomer-absorptive sheets”) and monomer-absorptive sheets having a monomer-absorptive layer formed on a base material (hereinafter, referred to as “base material-supported monomer-absorptive sheets”). When the monomer-absorptive sheet is a base material-less monomer-absorptive sheet, the monomer-absorptive surface may be formed on either surface, while when it is a base material-supported monomer-absorptive sheet, one surface of the monomer-absorptive layer surface is the monomer-absorptive surface.

Examples of the material forming the monomer-absorptive layer include paper sheets (e.g., Kraft paper, crepe paper, Japanese paper); fiber sheets (e.g., woven fabrics, nonwoven fabrics, nets); porous films; polymers (e.g., acrylic polymers, polyurethane resins, ethylene-vinyl acetate copolymers, epoxy resins); natural rubbers; synthetic rubbers and the like. The monomer-absorptive layers may be used alone or in combination of two or more.

As described above, the monomer-absorptive layer is not particularly limited, if it can absorb at least one of the polymerizable monomers used in the immiscible material-containing polymerizable composition and thus, the modulus of the monomer-absorptive layer is not particularly limited either. Thus, either a low-modulus material such as adhesive and polymer layer or a high-modulus material such as plastic sheet, hardcoat layer, and colored coat layer may be used as the monomer-absorptive layer, if it can absorb at least one polymerizable monomer used in the immiscible material-containing polymerizable composition.

In the present invention, the raw material for the monomer-absorptive layer may be preferably a polymer because it is superior in affinity to the monomers and also in absorption speed. Specifically, the monomer-absorptive layer for use may be preferably a polymeric monomer-absorptive polymer layer and the monomer-absorptive sheet for use may be preferably a sheet having a polymer layer. Such a polymer is not particularly limited, but preferably a polymer containing at least one polymerizable monomer constituting the immiscible material-containing polymerizable composition as the constituent monomer component. For example when an immiscible material-containing acrylic polymerizable composition is used as the immiscible material-containing polymerizable composition, the polymer forming the monomer-absorptive layer is preferably an acrylic polymer. It is because, when an acrylic monomer, a polymerizable monomer for the immiscible material-containing acrylic polymerizable composition, is identical with at least one of the constituent units for the acrylic polymer forming the monomer-absorptive layer, the acrylic monomer which is polymerizable monomer can migrate easily.

In addition, the monomer-absorptive layer may have a polymer layer obtained by polymerization of a polymerizable composition in composition similar to the immiscible material-containing polymerizable composition, except that the immiscible material is eliminated therefrom. For example, the monomer-absorptive layer may have a photopolymerization-cured layer obtained by curing of a photopolymerizable composition in a composition similar to the particle-containing photopolymerizable composition, except that the particles are eliminated therefrom.

Further, the monomer-absorptive layer may be a pressure-sensitive adhesive composition layer. When the monomer-absorptive layer is a pressure-sensitive adhesive composition layer, it is possible to obtain more integrated polymer member because all components in a particular laminate (monomer-absorptive layer/immiscible material-containing polymerizable layer/monomer-absorptive layer) are polymerized and cured simultaneously when polymerized. The pressure-sensitive adhesive composition layer is a layer formed with a pressure-sensitive adhesive composition, and the pressure-sensitive adhesive composition is a composition forming the adhesive. The monomer components forming the base material polymer of the adhesive in the pressure-sensitive adhesive composition may be partially polymerized.

Such a pressure-sensitive adhesive composition is not particularly limited, and examples thereof include pressure-sensitive adhesive compositions containing known pressure-sensitive adhesives (e.g., acrylic pressure-sensitive adhesives, rubber-based pressure-sensitive adhesives, vinyl alkyl ether-based pressure-sensitive adhesives, silicone-based pressure-sensitive adhesives, polyester-based pressure-sensitive adhesives, polyamide-based pressure-sensitive adhesives, urethane-based pressure-sensitive adhesives, fluorine-based pressure-sensitive adhesives, epoxy-based pressure-sensitive adhesives)

In particular, a monomer component constituting the pressure-sensitive adhesive composition is preferably identical with at least one of the polymerizable monomers constituting the immiscible material-containing polymerizable composition because affinity between the pressure-sensitive adhesive composition and the monomer is higher and the absorption speed is larger.

For example, when the immiscible material-containing polymerizable composition used is an immiscible material-containing acrylic polymerizable composition, the pressure-sensitive adhesive composition forming the monomer-absorptive layer is preferably an acrylic pressure-sensitive adhesive composition forming the acrylic adhesive layer. It is because, when the acrylic monomer, a polymerizable monomer for the immiscible material-containing acrylic polymerizable composition, is identical with at least one of the monomer components constituting the acrylic pressure-sensitive adhesive composition forming the monomer-absorptive layer, the acrylic monomer which is polymerizable monomer can migrate easily.

The pressure-sensitive adhesive composition layer used as the monomer-absorptive layer is formed, for example, by coating it on a particular face of a suitable substrate, such as the base material described below or the release-treated face of a cover film, in one of the following conventional coaters.

The volume of the monomer-absorptive layer may be constant or varied between before and after absorption of the polymerizable monomer. For example, when the monomer-absorptive layer is a layer formed with polymer substance [e.g., a polymer described above (acrylic polymer, polyurethane resin, ethylene-vinyl acetate copolymer, epoxy resin) or a polymer formed by polymerization of a polymerizable composition in composition similar to the immiscible material-containing polymerizable composition, except that the immiscible material is eliminated therefrom], the volume of the polymer substance layer which is the monomer-absorptive layer normally increases by absorption of the polymerizable monomer from the immiscible material-containing polymerizable composition layer. In other words, the polymer substance forming the monomer-absorptive layer swells by absorption of the polymerizable monomer. Thus, the monomer-absorptive layer is a monomer swelling layer that has a volume increased by absorption of the polymerizable monomer.

In addition, in the present invention, when a polymeric monomer-absorptive polymer layer is used as the monomer-absorptive layer, the gel fraction thereof is not particularly limited. It is thus possible to obtain a polymer member, if the monomer-absorptive polymer layer is crosslinked to a gel fraction of about 98 wt % or hardly crosslinked (gel fraction: 10 wt % or less). For example, when a monomer-absorptive polymer layer is used as the monomer-absorptive layer or when a sheet carrying a polymer layer is used as the monomer-absorptive sheet, it is possible to produce a polymer member if the polymer layer is crosslinked to a gel fraction of about 98 wt % or hardly crosslinked (gel fraction: 10 wt % or less). It is thus possible to provide the polymer layer formed as the monomer-absorptive layer in the resulting polymer member with favorable heat resistance and solvent resistance, by crosslinking the polymer layer to high crosslinking degree (for example, gel fraction: 90 wt % or more). It is also possible to provide the resulting polymer member with favorable flexibility and stress relaxation property, by crosslinking the polymer layer to low crosslinking degree (for example, gel fraction: 10 wt % or less).

Further, in the present invention, it is possible to obtain a polymer member, independently of whether the monomer-absorptive layer is a hard layer or a soft layer. Thus, when a hard layer (for example, layer having a 100% modulus of 100N/cm² or more) is used as the monomer-absorptive layer, the monomer-absorptive layer obtained may be used as the substrate (base material). Alternatively, when a soft layer (e.g., layer having a 100% modulus of 30N/cm² or less) is used as the monomer-absorptive layer, the monomer-absorptive layer obtained may be used as the pressure-sensitive adhesive layer.

When the monomer-absorptive layer is, for example, a layer of the polymer substance, the monomer-absorptive layer is formed, for example, by coating the polymer substance or the polymerizable composition formed by polymerization of the polymer substance (hereinafter, referred to as “monomer-absorptive layer-forming composition”) on a particular face of a suitable substrate such as the release-treated face of the following base material or cover film by means of a conventional coater described above. The monomer-absorptive-layer-forming composition formed on the substrate is normally dried and/or cured (for example, cured by light irradiation), as needed. When the monomer-absorptive layer-forming composition is coated on a particular face of a suitable substrate, it may be adjusted to a viscosity suitable for coating, for example, as it is blended with various polymers such as acrylic rubbers and thickening additives or as its monomer component is partially polymerized by heating or photoirradiation (irradiation of active energy ray).

The thickness of the monomer-absorptive layer before absorption of polymerizable monomer is not particularly limited and can be selected, for example, in the range of 1 to 3000 μm (preferably 2 to 2000 μm, more preferably 5 to 1000 μm). A thickness of less than 1 μm may cause concern about deformation of the sheet by absorption of a large amount of polymerizable monomer or insufficient absorption of the polymerizable monomer, while a thickness of more than 3000 μm may cause problems in handling efficiency, for example by making it difficult to roll up the sheet. The monomer-absorptive layer may have either a shape of single layer or laminate layer.

Examples of the base materials (base materials for monomer-absorptive sheet) for use when the monomer-absorptive sheet is a base material-supported monomer-absorptive sheet are suitable thin leaf-shaped materials including paper-based base materials such as paper; fiber-based base materials such as woven fabrics, nonwoven fabrics, and nets; metal-based base materials such as metal foils and metal plates; plastic base materials such as plastic films and sheets; rubber-based base materials such as rubber sheets; foams such as foam sheets; the laminates thereof [for example, laminates of a plastic base material and another base material, laminates of plastic films (or sheets)] and the like. The base materials favorably used are plastic base materials such as plastic films and sheets. Examples of the raw materials for the plastic films and sheets include olefinic resins prepared from one or more monomer components of α-olefins such as polyethylene (PE), polypropylene (PP), ethylene-propylene copolymers, and ethylene-vinyl acetate copolymers (EVA); polyester resins such as polyethylene terephthalate (PET), polyethylene naphthalate (PEN), and polybutylene terephthalate (PBT); polyvinyl chloride (PVC); vinyl acetate resins; polyphenylene sulfide (PPS); amide resins such as polyamides (nylon), and wholly aromatic polyamides (aramide); polyimide resins; polyether ether ketone (PEEK) and the like. These raw materials may be used alone or in combination of two or more.

When a plastic base material is used as the base material for monomer-absorptive sheet, deformation thereof such as elongation may be controlled, for example, by drawing treatment. Alternatively, when the monomer-absorptive layer is formed by curing with an active energy ray, a sheet that does not inhibit transmission of the active energy ray is preferably used as the base material for monomer-absorptive sheet.

For improvement of the adhesiveness to the monomer-absorptive layer, the surface of the base film for the monomer-absorptive sheet may, for example, be oxidized by a conventional surface treatment, specifically by a chemical or physical method such as corona treatment, chromate treatment, ozone exposure, flame exposure, high-pressure electrical shock exposure or ionizing radiation treatment, or subjected to a coating treatment, for example, with a primer or a release agent.

The thickness of the base material for monomer-absorptive sheet can be selected in accordance with desired strength and flexibility and also to desired application and is, for example, generally 1000 μm or less (e.g., 1 to 1000 μm), preferably 1 to 500 μm, more preferably about 3 to 300 μm, although it is not limited to the region. The base material may have either a shape of single layer or laminate layer.

In production of a polymer member, it is possible according to the present invention to produce the polymer member by using an immiscible material-containing polymerizable composition without removal by distillation of the volatile components (e.g., solvents, organic compounds) contained in the immiscible material-containing polymerizable composition. Thus, the production process is advantageous from the environmental point of view.

### [Polymer Member]

In the present invention, the polymer member is prepared by laminating a monomer-absorptive layer that can absorb a polymerizable monomer on both faces of an immiscible material-containing polymerizable composition layer containing an immiscible material immiscible with the polymer obtained by polymerization of the polymerizable monomers and polymerizing the laminate. The polymer member has an unevenly distributed structure in which the immiscible material is not present at the interface between the immiscible material-containing polymerizable composition layer and the monomer-absorptive layers immediately after lamination. The unevenly distributed structure of the immiscible material in such a polymer member is a structure in which the immiscible material is enriched in the thickness direction in the shape of layer located in central region.

Such a polymer member can be prepared by the process for producing a polymer member described above. For example, it is produced by preparing a laminate by laminating an immiscible material-containing polymerizable composition layer on the monomer-absorptive layer of a monomer-absorptive sheet and laminating another monomer-absorptive sheet additionally on the immiscible material-containing polymerizable composition layer in the shape in which the monomer-absorptive layer and the immiscible material-containing polymerizable composition layer are in contact with each other; forming an unevenly distributed structure in which the immiscible material is not present at the interface between the immiscible material-containing polymerizable composition layer and the monomer-absorptive layers immediately after lamination by polymerization of the laminate. Alternatively, the polymer member can also be prepared by preparing a laminate by forming an immiscible material-containing photopolymerizable composition layer on the monomer-absorptive layer (monomer-absorptive surface) of a monomer-absorptive sheet, laminating another monomer-absorptive sheet additionally on the immiscible material-containing photopolymerizable composition layer in the shape in which the immiscible material-containing photopolymerizable composition layer and the monomer-absorptive surface are in contact with each other and forming an unevenly distributed structure in which the immiscible material is not present at the interface between the immiscible material-containing polymerizable composition layer and the monomer-absorptive layers immediately after lamination by polymerization by irradiation of an active energy ray.

The shape of the polymer member is not particularly limited, but the polymer member normally has a sheet or tape shape. When an adhesive layer (pressure-sensitive adhesive layer) is used as the monomer-absorptive layer, it is possible to use the polymer member as a pressure-sensitive adhesive tape or sheet (hereinafter, the “tape or sheet” may be referred to as “tape” or “sheet”) by making the outermost layer of the polymer member a monomer-absorptive layer.

It is also possible to use the polymer member as an adhesive tape or sheet, by forming an adhesive layer (pressure-sensitive adhesive layer) of a known adhesive (pressure-sensitive adhesive) (e.g., acrylic adhesive, rubber-based adhesive, vinyl alkyl ether-based adhesive, silicone-based adhesive, polyester-based adhesive, polyamide-based adhesive, urethane-based adhesive, fluorine-based adhesive, epoxy-based adhesive) on the polymer member.

The polymer member may have other layers (e.g., intermediate layer, undercoat layer) if it does not impair the advantageous effects of the invention.

In the polymer member, the surface of the member may be protected with a cover film. The cover film may be releasable or not releasable. The cover film may be removed or not removed before use of the polymer member or may constitute part of the polymer member, as it remains in that state. In the present invention, when the photopolymerization method is used, it is desirable to block oxygen in air with a cover film because oxygen in air can inhibit the reaction.

Such a cover film is not particularly limited, if it is a thin leaf-shaped material inhibiting oxygen permeation, but preferably a transparent film when a photopolymerization reaction is used and, for example, a conventional release liner (peel-away backing) can be used. Typical examples of the cover films include base materials having a releasably treated layer (releasable layer) with a release agent (parting agent) on at least one surface; low-adhesiveness base materials such as of a fluorochemical polymer (e.g., polytetrafluoroethylene, polychlorotrifluoroethylene, polyvinyl fluoride, polyvinylidene fluoride, a tetrafluoroethylene-hexafluoropropylene copolymer or a chlorofluoroethylene-vinylidene fluoride copolymer); and low-adhesiveness base materials of a non-polar polymer (e.g., olefinic resin such as polyethylene or polypropylene). In the case of a low-adhesiveness base material, both faces thereof may be used as the release surfaces, while, in the case of a base material having a releasably treated layer, the releasably treated layer surface may be used as the release surface (releasably treated face).

The cover film for use may be, for example, a cover film having a releasably treated layer formed on at least one face of the base material for cover film (base material having a releasably treated layer), or the base material for cover film may be used as it is.

Examples of the base materials for cover film include plastic base material films (synthetic resin films) such as polyester films (polyethylene terephthalate film, etc.), olefinic resin films (polyethylene film, polypropylene film, etc.), polyvinyl chloride films, polyimide films, polyamide films (nylon films), and rayon films; papers (woodfree paper, Japanese paper, Kraft paper, glassine paper, synthetic paper, topcoat paper, etc.); the laminates thereof formed by lamination or coextrusion (2- to 3-layered laminates) and the like. The base material for cover film for use may be a base material for cover film having of a plastic base material film (in particular, polyethylene terephthalate film) higher in transparency.

The release agent is not particularly limited and, for example, silicone-based releasing agents, fluorine-based releasing agents, long-chain alkyl-based releasing agents, and others are used favorably. The release agents may be used alone or in combination of two or more. The cover film release-treated with a release agent can be prepared, for example, by a known production method.

The thickness of the cover film is not particularly limited but selected, for example, in the range of 12 to 250 μm (preferably, 20 to 200 μm) from the viewpoints of handling efficiency and economy. The cover film may have either a shape of single layer or laminate layer.

The thickness of the entire polymer member is not particularly limited, but preferably 1 to 3000 μm, more preferably 10 to 1000 μm, and still more preferably 50 to 500 μm, from the viewpoints of possibility of deformation and handling efficiency, for example during winding rolling up the sheet. The thickness of the entire polymer member is the thickness of the region obtained by polymerization of the laminate obtained by lamination of a monomer-absorptive layer on both faces of an immiscible material-containing polymerizable composition layer (particular laminate) and does not include the thickness of the cover film or the base material for monomer-absorptive sheet.

The thickness of the polymer layer in which the immiscible material is unevenly distributed in the polymer member is not particularly limited, but 1 to 3000 μm, preferably 10 to 1000 μm, and more preferably 50 to 500 μm, from the points of possibility of deformation and handling efficiency, for example during rolling up the sheet. The polymer layer in which the immiscible material is distributed unevenly is a hypothetical polymer layer considered to be obtained with the immiscible material-containing polymerizable composition layer in the polymer member obtained by polymerization of the particular laminate (laminate of monomer-absorptive layer/immiscible material-containing polymerizable composition layer/monomer-absorptive layer), and the thickness of the polymer layer in which the immiscible material is distributed unevenly is a theoretical value calculated by subtracting the thickness of the monomer-absorptive layer from the entire thickness. In each Figure, the polymer layer in which the immiscible material is distributed unevenly is shown as layer A.

The thickness of the region where the immiscible material is distributed in the polymer member is not particularly limited, but preferably 0.1 to 500 μm, more preferably 0.5 to 300 μm, and still more preferably 1 to 100 μm, from the viewpoints of the strength of the member and handling efficiency, for example during rolling up the sheet. The region in the polymer member where the immiscible material is distributed may be referred to as an “immiscible material-enriched region”. In each Figure, the immiscible material-enriched region is shown as layer C.

The thickness of the immiscible material-enriched region is 50% or less (preferably 40% or less, more preferably 30% or less) of the thickness of the immiscible material-unevenly distributed polymer layer. As described above, the immiscible material-unevenly distributed polymer layer is a hypothetical layer. It would be probably because, if the immiscible material-containing polymerizable composition layer is formed so that contact with the monomer-absorptive layer, at least one monomer component in the immiscible material-containing polymerizable composition layer is absorbed in the monomer-absorptive layer, causing migration of the immiscible material, and a monomer-absorptive layer is formed on both faces of the immiscible material-containing polymerizable composition layer.

Thus, the period from contact of the immiscible material-containing polymerizable composition layer with the monomer-absorptive layer to termination of polymerization of the laminate is preferably as long as possible. In particular, when initiation of polymerization is easily controlled by photoirradiation (in particular, irradiation of active energy ray), it is preferable to start photoirradiation (in particular, irradiation of active energy ray), 1 second or more, preferably 5 seconds or more, and still more preferably 10 seconds or more (normally within 24 hours) after the contact.

The thickness of the region where the immiscible material is distributed (immiscible material-enriched region) can be controlled by adjustment of the amount of the immiscible material.

The thickness of the immiscible material-enriched region is preferably 0.1 to 50%, more preferably 1 to 20%, of the thickness of the entire polymer member, from the concern about the problem of adhesion between the immiscible material-enriched region and the other region in the polymer member and from the viewpoint of the strength of the polymer member.

Accordingly, as the immiscible material is enriched unevenly in the internal certain layer region, the polymer member is integrated as a whole. The polymer member is also superior in strength.

The region in the polymer member where the immiscible material is distributed contains both the immiscible material and the polymer component. Thus, the region shows the properties based on the polymer component, the properties inherent to the immiscible material, and the properties based on uneven distribution of the immiscible material in the polymer member.

Examples of the properties based on the polymer component include flexibility, hard-coating efficiency, tackiness, stress relaxation property, impact resistance and the like. Examples of the properties inherent to the immiscible material include the particular functions of the immiscible material having particular functions (e.g., expandability, shrinkability, high absorption efficiency, divergence, conductivity) exhibited when it is used. The properties based on uneven distribution of the immiscible material in the polymer member are, for example, properties of the base material (e.g., flexibility, hard-coating efficiency, tackiness, stress relaxation property, impact resistance) together with the properties inherent to the immiscible material (e.g., expandability, shrinkability, absorption efficiency, divergence, conductivity).

Since the polymer member according to the present invention shows various properties, for example, when the kind and amount of the immiscible material, the kind of the polymer of the polymer member or the thickness thereof is adjusted, it can be used in various application fields. For example, it can be used in applications of optical sheets, electronic circuits, power electronics materials, adhesive tapes, medical applications and others.

### EXAMPLES

The present invention will be illustrated in more detail with reference to Examples below, but it should be noted that these examples are never construed to limit the scope of the present invention.

### (Preparation Example of Photopolymerizable Sirup 1)

100 parts by weight of cyclohexyl acrylate as a monomer component, 0.1 part by weight of a photopolymerization initiator (trade name: “Irgacure 651” manufactured by Ciba Specialty Chemicals Corporation Corporation), and 0.1 part by weight of another photopolymerization initiator (trade name: “Irgacure 184” manufactured by Ciba Specialty Chemicals Corporation Corporation) were stirred in a four-necked flask equipped with a separable stirrer, a thermometer, a nitrogen gas inlet tube, and a condenser, to give a homogeneous mixture, which was then bubbled with nitrogen gas for 1 hour to remove dissolved oxygen therefrom. Thereafter, the mixture was polymerized by ultraviolet ray irradiated into the flask externally from a black light lamp, and the lamp was turned off and the nitrogen bubbling terminated when the mixture obtained a suitable viscosity, to give a partially polymerized composition (syrup) having a polymerization degree of 7% (hereinafter, referred to as a “photopolymerizable syrup (A)”).

### (Preparation Example of Photopolymerizable Sirup 2)

100 parts by weight of butyl acrylate as a monomer component, 0.1 part by weight of a photopolymerization initiator (trade name: “Irgacure 651” manufactured by Ciba Specialty Chemicals Corporation Corporation), and 0.1 part by weight of another photopolymerization initiator (trade name: “Irgacure 184” manufactured by Ciba Specialty Chemicals Corporation Corporation) were stirred in a four-necked flask equipped with a separable stirrer, a thermometer, a nitrogen gas inlet tube, and a condenser, to give a homogeneous mixture, which was then bubbled with nitrogen gas for 1 hour to remove dissolved oxygen therefrom. Thereafter, the mixture was polymerized by ultraviolet ray irradiated into the flask externally from a black light lamp, and the lamp was turned off and the nitrogen bubbling terminated when the mixture obtained a suitable viscosity, to give a partially polymerized composition (syrup) having a polymerization degree of 7% (hereinafter, referred to as a “photopolymerizable syrup (B)”).

### (Preparation Example of Photopolymerizable Sirup 3)

100 parts by weight of 2-ethlhexyl acrylate as a monomer component, 0.1 part by weight of a photopolymerization initiator (trade name: “Irgacure 651” manufactured by Ciba Specialty Chemicals Corporation Corporation), and 0.1 part by weight of another photopolymerization initiator (trade name: “Irgacure 184” manufactured by Ciba Specialty Chemicals Corporation Corporation) were stirred in a four-necked flask equipped with a separable stirrer, a thermometer, a nitrogen gas inlet tube, and a condenser, to give a homogeneous mixture, which was then bubbled with nitrogen gas for 1 hour to remove dissolved oxygen therefrom. Thereafter, the mixture was polymerized by ultraviolet ray irradiated into the flask externally from a black light lamp, and the lamp was turned off and the nitrogen bubbling terminated when the mixture obtained a suitable viscosity, to give a partially polymerized composition (syrup) having a polymerization degree of 7% (hereinafter, referred to as a “photopolymerizable syrup (C)”).

### (Preparation Example of Photopolymerizable Sirup 4)

100 parts by weight of tetrahydrofurfuryl acrylate as a monomer component, 0.1 part by weight of a photopolymerization initiator (trade name: “Irgacure 651” manufactured by Ciba Specialty Chemicals Corporation Corporation), and 0.1 part by weight of another photopolymerization initiator (trade name: “Irgacure 184” manufactured by Ciba Specialty Chemicals Corporation Corporation) were stirred in a four-necked flask equipped with a separable stirrer, a thermometer, a nitrogen gas inlet tube, and a condenser, to give a homogeneous mixture, which was then bubbled with nitrogen gas for 1 hour to remove dissolved oxygen therefrom. Thereafter, the mixture was polymerized by ultraviolet ray irradiated into the flask externally from a black light lamp, and the lamp was turned off and the nitrogen bubbling terminated when the mixture obtained a suitable viscosity, to give a partially polymerized composition (syrup) having a polymerization degree of 7% (hereinafter, referred to as a “photopolymerizable syrup (D)”).

### (Preparation Example of Photopolymerizable Sirup 5)

100 parts by weight by weight of cyclohexyl acrylate as a monomer component, 20 parts by weight of SEBS (styrene-ethylene-butylene-styrene copolymer) (trade name: “G1726” manufactured by Kraton Performance Polymers Inc.) as an immiscible material and 0.1 part by weight of 1,6-hexanediol diacrylate were dissolved; 0.2 part by weight of “Irgacure 651” (trade name, manufactured by Ciba Specialty Chemicals Corporation), and 0.2 part by weight of “Irgacure 184” (trade name, manufactured by Ciba Specialty Chemicals Corporation) as photopolymerization initiators were additionally dissolved therein, to give a homogeneous transparent viscous solution (sirup) (hereinafter, referred to as a “photopolymerizable sirup (E)”).

### (Preparation Example of Photopolymerizable Sirup 6)

100 parts by weight by weight of 2-ethylhexyl acrylate as a monomer component, 20 parts by weight of SEBS (styrene-ethylene-butylene-styrene copolymer) (trade name: “G1726” manufactured by Kraton Performance Polymers Inc.) as an immiscible material and 0.1 part by weight of 1,6-hexanediol diacrylate were dissolved; 0.2 part by weight of “Irgacure 651” (trade name, manufactured by Ciba Specialty Chemicals Corporation), and 0.2 part by weight of “Irgacure 184” (trade name, manufactured by Ciba Specialty Chemicals Corporation) as photopolymerization initiators were additionally dissolved therein, to give a homogeneous transparent viscous solution (sirup) (hereinafter, referred to as a “photopolymerizable sirup (F)”).

### (Preparation Example of Particle-Containing Photopolymerizable Composition 1)

100 parts by weight of the photopolymerizable sirup (A), 10 parts by weight of crosslinked acrylic particles having an average diameter of 5 μm (trade name: “MX-500”, manufactured by Soken Chemical & Engineering Co., Ltd.), 0.1 part by weight of 1,6-hexanediol diacrylate, and 0.1 part by weight of “Irgacure 651” (trade name, manufactured by Ciba Specialty Chemicals Corporation) and 0.1 part by weight of “Irgacure 184” (trade name, manufactured by Ciba Specialty Chemicals Corporation) as photopolymerization initiators were mixed uniformly, to give a particle-containing photopolymerizable composition (hereinafter, referred to as a “particle-containing photopolymerizable composition (A)”).

### (Preparation Example of Particle-Containing Photopolymerizable Composition 2)

100 parts by weight of the photopolymerizable sirup (A), 5 parts by weight of crosslinked acrylic particles having an average diameter of 5 μm (trade name: “MX-500”, manufactured by Soken Chemical & Engineering Co., Ltd.), 0.1 part by weight of 1,6-hexanediol diacrylate, and 0.1 part by weight of “Irgacure 651” (trade name, manufactured by Ciba Specialty Chemicals Corporation) and 0.1 part by weight of “Irgacure 184” (trade name, manufactured by Ciba Specialty Chemicals Corporation) as photopolymerization initiators were mixed uniformly, to give a particle-containing photopolymerizable composition (hereinafter, referred to as a “particle-containing photopolymerizable composition (B)”).

### (Preparation Example of Particle-Containing Photopolymerizable Composition 3)

100 parts by weight of the photopolymerizable sirup (B), 10 parts by weight of crosslinked acrylic particles having an average diameter of 5 μm (trade name: “MX-500”, manufactured by Soken Chemical & Engineering Co., Ltd.), 0.1 part by weight of 1,6-hexanediol diacrylate, and 0.1 part by weight of “Irgacure 651” (trade name, manufactured by Ciba Specialty Chemicals Corporation) and 0.1 part by weight of “Irgacure 184” (trade name, manufactured by Ciba Specialty Chemicals Corporation) as photopolymerization initiators were mixed uniformly, to give a particle-containing photopolymerizable composition (hereinafter, referred to as a “particle-containing photopolymerizable composition (C)”).

### (Preparation Example Of Particle-Containing Photopolymerizable Composition 4)

100 parts by weight of the photopolymerizable sirup (A), 10 parts by weight of barium titanate having an average diameter of 500 nm (trade name: “BT-05”, manufactured by Sakai Chemical Industry Co., Ltd.), 0.1 part by weight of 1,6-hexanediol diacrylate, and 0.1 part by weight of “Irgacure 651” (trade name, manufactured by Ciba Specialty Chemicals Corporation) and 0.1 part by weight of “Irgacure 184” (trade name, manufactured by Ciba Specialty Chemicals Corporation) as photopolymerization initiators were mixed uniformly, to give a particle-containing photopolymerizable composition (hereinafter, referred to as a “particle-containing photopolymerizable composition (D)”).

### (Preparation Example of Particle-Containing Photopolymerizable Composition 5)

100 parts by weight of the photopolymerizable sirup (A), 10 parts by weight of stannic oxide and antimony conductive layer-coated spicular rutile titanium oxide (trade name: “FT-3000”, manufactured by ISHIHARA SANGYO KAISHA, LTD., average minor-axis particle diameter: 0.27 μm, average major-axis particle diameter: 5.15 μm), 0.1 part by weight of 1,6-hexanediol diacrylate, and 0.1 part by weight of “Irgacure 651” (trade name, manufactured by Ciba Specialty Chemicals Corporation) and 0.1 part by weight of “Irgacure 184” (trade name, manufactured by Ciba Specialty Chemicals Corporation) as photopolymerization initiators were mixed uniformly, to give a particle-containing photopolymerizable composition (hereinafter, referred to as a “particle-containing photopolymerizable composition (E)”).

### (Preparation Example of Particle-Containing Photopolymerizable Composition 6)

100 parts by weight of the photopolymerizable sirup (A), 40 parts by weight of nickel fine particles (trade name: “Ni210”, manufactured by Inco TNC Limited, average diameter: 0.5 μm to 1.0 μm), 0.1 part by weight of 1,6-hexanediol diacrylate, and 0.1 part by weight of “Irgacure 651” (trade name, manufactured by Ciba Specialty Chemicals Corporation) and 0.1 part by weight of “Irgacure 184” (trade name, manufactured by Ciba Specialty Chemicals Corporation) as photopolymerization initiators were mixed uniformly, to give a particle-containing photopolymerizable composition (hereinafter, referred to as a “particle-containing photopolymerizable composition (F)”).

### (Cover Film)

A cover film used herein was a biaxially oriented poly(ethylene terephthalate) film having a thickness of 38 μm (trade name: “MRN38”, manufactured by Mitsubishi Polyester Film Inc.), one surface of which had been treated with a silicone release agent.

### (Preparation Example of Base Material-Supported Monomer-Absorptive Sheet 1)

A photopolymerizable syrup composition prepared by homogeneously mixing 100 parts by weight of the photopolymerizable syrup (A) with 0.1 part by weight of 1,6-hexanediol diacrylate (hereinafter, also referred to as a “photopolymerizable syrup composition (A)”) was coated on one surface of a biaxially oriented poly(ethylene terephthalate) film having a thickness of 38 μm to a post-curing thickness of 108 μm, to form a photopolymerizable sirup composition layer. The cover film was applied to the photopolymerizable syrup layer so that the releasably treated surface of the cover film was in contact with the layer; and the layer was cured by irradiation of ultraviolet ray (illuminance; 5 mW/cm²) for 3 minutes by using a black light lamp, to form a monomer-absorptive layer and to give a base material-supported monomer-absorptive sheet of which the monomer-absorptive layer surface is protected by the cover film (hereinafter, referred to as a “base material-supported monomer-absorptive sheet (A)”).

### (Preparation Example of Base Material-Supported Monomer-Absorptive Sheet 2)

A photopolymerizable syrup composition prepared by homogeneously mixing 100 parts by weight of the photopolymerizable syrup (A) with 0.1 part by weight of 1,6-hexanediol diacrylate (hereinafter, also referred to as a “photopolymerizable syrup composition (A)”) was coated on one surface of a biaxially oriented poly(ethylene terephthalate) film having a thickness of 38 μm to a post-curing thickness of 40 μm, to form a photopolymerizable sirup composition layer. The cover film was applied to the photopolymerizable syrup layer so that the releasably treated surface of the cover film was in contact with the layer; and the layer was cured by irradiation of ultraviolet ray (illuminance; 5 mW/cm²) for 3 minutes by using a black light lamp, to form a monomer-absorptive layer and to give a base material-supported monomer-absorptive sheet of which the monomer-absorptive layer surface is protected by the cover film (hereinafter, referred to as a “base material-supported monomer-absorptive sheet (B)”).

### (Preparation Example of Base Material-Supported Monomer-Absorptive Sheet 3)

A photopolymerizable syrup composition prepared by homogeneously mixing 100 parts by weight of the photopolymerizable syrup (B) with 0.1 part by weight of 1,6-hexanediol diacrylate (hereinafter, also referred to as a “photopolymerizable syrup composition (B)”) was coated on one surface of a biaxially oriented poly(ethylene terephthalate) film having a thickness of 38 μm to a post-curing thickness of 37 μm, to form a photopolymerizable sirup composition layer. The cover film was applied to the photopolymerizable syrup layer so that the releasably treated surface of the cover film was in contact with the layer; and the layer was cured by irradiation of ultraviolet ray (illuminance; 5 mW/cm²) for 3 minutes by using a black light lamp, to form a monomer-absorptive layer and to give a base material-supported monomer-absorptive sheet of which the monomer-absorptive layer surface is protected by the cover film (hereinafter, referred to as a “base material-supported monomer-absorptive sheet (C)”).

### (Preparation Example of Base Material-Supported Monomer-Absorptive Sheet 4)

A photopolymerizable syrup composition prepared by homogeneously mixing 100 parts by weight of the photopolymerizable syrup (C) with 0.1 part by weight of 1,6-hexanediol diacrylate (hereinafter, also referred to as a “photopolymerizable syrup composition (C)”) was coated on one surface of a biaxially oriented poly(ethylene terephthalate) film having a thickness of 38 μm to a post-curing thickness of 38 μm, to form a photopolymerizable sirup composition layer. The cover film was applied to the photopolymerizable syrup layer so that the releasably treated surface of the cover film was in contact with the layer; and the layer was cured by irradiation of ultraviolet ray (illuminance; 5 mW/cm²) for 3 minutes by using a black light lamp, to form a monomer-absorptive layer and to give a base material-supported monomer-absorptive sheet of which the monomer-absorptive layer surface is protected by the cover film (hereinafter, referred to as a “base material-supported monomer-absorptive sheet (D)”).

### (Preparation Example of Base Material-Supported Monomer-Absorptive Sheet 5)

A photopolymerizable syrup composition prepared by homogeneously mixing 100 parts by weight of the photopolymerizable syrup (D) with 0.1 part by weight of 1,6-hexanediol diacrylate (hereinafter, also referred to as a “photopolymerizable syrup composition (D)”) was coated on one surface of a biaxially oriented poly(ethylene terephthalate) film having a thickness of 38 μm to a post-curing thickness of 33 μm, to form a photopolymerizable sirup composition layer. The cover film was applied to the photopolymerizable syrup layer so that the releasably treated surface of the cover film was in contact with the layer; and the layer was cured by irradiation of ultraviolet ray (illuminance; 5 mW/cm²) for 3 minutes by using a black light lamp, to form a monomer-absorptive layer and to give a base material-supported monomer-absorptive sheet of which the monomer-absorptive layer surface is protected by the cover film (hereinafter, referred to as a “base material-supported monomer-absorptive sheet (E)”).

### Example 1

The particle-containing photopolymerizable composition layer (thickness: 100 μm), which was formed on the area of the base material-supported monomer-absorptive sheet (B) where the monomer-absorptive layer was exposed by removal of the cover film by coating the particle-containing photopolymerizable composition (A) thereon was bonded to the area of the base material-supported monomer-absorptive sheet (B) where the monomer-absorptive layer was exposed by removal of the cover film in such a manner that the monomer-absorptive layer and the particle-containing photopolymerizable composition layer are in contact with each other, to give a laminate.

Then, the laminate was irradiated with ultraviolet ray (illuminance: 5 mW/cm²) for 3 minutes from a light source of black light lamp 1 minute after preparation of the laminate, to give a polymer sheet.

### Example 2

The particle-containing photopolymerizable composition layer (thickness: 50 μm), which was formed on the area of the base material-supported monomer-absorptive sheet (B) where the monomer-absorptive layer was exposed by removal of the cover film by coating the particle-containing photopolymerizable composition (A) thereon was bonded to the area of the base material-supported monomer-absorptive sheet (B) where the monomer-absorptive layer was exposed by removal of the cover film in such a manner that the monomer-absorptive layer and the particle-containing photopolymerizable composition layer are in contact with each other, to give a laminate.

Then, the laminate was photocured by irradiation with ultraviolet ray (illuminance: 5 mW/cm²) for 3 minutes from a light source of black light lamp 1 minute after preparation of the laminate, to give a polymer sheet.

### Example 3

The particle-containing photopolymerizable composition layer (thickness: 100 μm), which was formed on the area of the base material-supported monomer-absorptive sheet (B) where the monomer-absorptive layer was exposed by removal of the cover film by coating the particle-containing photopolymerizable composition (B) thereon was bonded to the area of the base material-supported monomer-absorptive sheet (B) where the monomer-absorptive layer was exposed by removal of the cover film in such a manner that the monomer-absorptive layer and the particle-containing photopolymerizable composition layer are in contact with each other, to give a laminate.

Then, the laminate was photocured by irradiation with ultraviolet ray (illuminance: 5 mW/cm²) for 3 minutes from a light source of black light lamp 1 minute after preparation of the laminate, to give a polymer sheet.

### Example 4

The particle-containing photopolymerizable composition layer (thickness: 100 μm), which was formed on the area of the base material-supported monomer-absorptive sheet (A) where the monomer-absorptive layer was exposed by removal of the cover film by coating the particle-containing photopolymerizable composition (A) thereon was bonded to the area of the base material-supported monomer-absorptive sheet (B) where the monomer-absorptive layer was exposed by removal of the cover film in such a manner that the monomer-absorptive layer and the particle-containing photopolymerizable composition layer are in contact with each other, to give a laminate.

Then, the laminate was photocured by irradiation with ultraviolet ray (illuminance: 5 mW/cm²) for 3 minutes from a light source of black light lamp 1 minute after preparation of the laminate, to give a polymer sheet.

### Example 5

The particle-containing photopolymerizable composition layer (thickness: 100 μm), which was formed on the area of the base material-supported monomer-absorptive sheet (E) where the monomer-absorptive layer was exposed by removal of the cover film by coating the particle-containing photopolymerizable composition (C) thereon was bonded to the area of the base material-supported monomer-absorptive sheet (C) where the monomer-absorptive layer was exposed by removal of the cover film in such a manner that the monomer-absorptive layer and the particle-containing photopolymerizable composition layer are in contact with each other, to give a laminate.

Then, the laminate was photocured by irradiation with ultraviolet ray (illuminance: 5 mW/cm²) for 3 minutes from a light source of black light lamp 1 minute after preparation of the laminate, to give a polymer sheet.

### Example 6

The particle-containing photopolymerizable composition layer (thickness: 100 μm), which was formed on the area of the base material-supported monomer-absorptive sheet (B) where the monomer-absorptive layer was exposed by removal of the cover film by coating the particle-containing photopolymerizable composition (B) thereon was bonded to the area of the base material-supported monomer-absorptive sheet (D) where the monomer-absorptive layer was exposed by removal of the cover film in such a manner that the monomer-absorptive layer and the particle-containing photopolymerizable composition layer are in contact with each other, to give a laminate.

Then, the laminate was photocured by irradiation with ultraviolet ray (illuminance: 5 mW/cm²) for 3 minutes from a light source of black light lamp 1 minute after preparation of the laminate, to give a polymer sheet.

### Example 7

The particle-containing photopolymerizable composition layer (thickness: 100 μm), which was formed on the area of the base material-supported monomer-absorptive sheet (B) where the monomer-absorptive layer was exposed by removal of the cover film by coating the particle-containing photopolymerizable composition (D) thereon was bonded to the area of the base material-supported monomer-absorptive sheet (B) where the monomer-absorptive layer was exposed by removal of the cover film in such a manner that the monomer-absorptive layer and the particle-containing photopolymerizable composition layer are in contact with each other, to give a laminate.

Then, the laminate was photocured by irradiation with ultraviolet ray (illuminance: 5 mW/cm²) for 3 minutes from a light source of black light lamp 1 minute after preparation of the laminate, to give a polymer sheet.

### Example 8

The particle-containing photopolymerizable composition layer (thickness: 100 μm), which was formed on the area of the base material-supported monomer-absorptive sheet (B) where the monomer-absorptive layer was exposed by removal of the cover film by coating the particle-containing photopolymerizable composition (E) thereon was bonded to the area of the base material-supported monomer-absorptive sheet (B) where the monomer-absorptive layer was exposed by removal of the cover film in such a manner that the monomer-absorptive layer and the particle-containing photopolymerizable composition layer are in contact with each other, to give a laminate.

Then, the laminate was photocured by irradiation with ultraviolet ray (illuminance: 5 mW/cm²) for 3 minutes from a light source of black light lamp 1 minute after preparation of the laminate, to give a polymer sheet.

### Example 9

The particle-containing photopolymerizable composition layer (thickness: 100 μm), which was formed on the area of the base material-supported monomer-absorptive sheet (B) where the monomer-absorptive layer was exposed by removal of the cover film by coating the particle-containing photopolymerizable composition (F) thereon was bonded to the area of the base material-supported monomer-absorptive sheet (B) where the monomer-absorptive layer was exposed by removal of the cover film in such a manner that the monomer-absorptive layer and the particle-containing photopolymerizable composition layer are in contact with each other, to give a laminate.

Then, the laminate was photocured by irradiation with ultraviolet ray (illuminance: 5 mW/cm²) for 3 minutes from a light source of black light lamp 1 minute after preparation of the laminate, to give a polymer sheet.

### Example 10

The immiscible material-containing photopolymerizable composition layer (thickness: 100 μm), which was formed on the area of the base material-supported monomer-absorptive sheet (B) where the monomer-absorptive layer was exposed by removal of the cover film by coating the photopolymerizable syrup (E) thereon was bonded to the area of the base material-supported monomer-absorptive sheet (B) where the monomer-absorptive layer was exposed by removal of the cover film in such a manner that the monomer-absorptive layer and the immiscible material-containing photopolymerizable composition layer are in contact with each other, to give a laminate.

Then, the laminate was photocured by irradiation with ultraviolet ray (illuminance: 5 mW/cm²) for 3 minutes from a light source of black light lamp 1 minute after preparation of the laminate, to give a polymer sheet.

### Example 11

The immiscible material-containing photopolymerizable composition layer (thickness: 100 μm), which was formed on the area of the base material-supported monomer-absorptive sheet (B) where the monomer-absorptive layer was exposed by removal of the cover film by coating the photopolymerizable syrup (F) thereon was bonded to the area of the base material-supported monomer-absorptive sheet (B) where the monomer-absorptive layer was exposed by removal of the cover film in such a manner that the monomer-absorptive layer and the immiscible material-containing photopolymerizable composition layer are in contact with each other, to give a laminate.

Then, the laminate was photocured by irradiation with ultraviolet ray (illuminance: 5 mW/cm²) for 3 minutes from a light source of black light lamp 1 minute after preparation of the laminate, to give a polymer sheet.

### Comparative Example 1

A particle-containing photopolymerizable composition layer (thickness: 100 μm) was prepared by coating the particle-containing photopolymerizable composition (A) on a biaxially oriented poly(ethylene terephthalate) film having a thickness of 38 μm, and a biaxially oriented poly(ethylene terephthalate) film having a thickness of 38 μm was bonded additionally to the particle-containing photopolymerizable composition layer, to give a laminate.

Then, the particle-containing photopolymerizable composition layer was photocured by irradiation of the laminate with ultraviolet ray (illuminance: 5 mW/cm²) for 3 minutes from a light source of a black light lamp 1 minute after preparation of the laminate, forming a particle-containing photopolymerization-cured layer, to give a sheet having a biaxially oriented poly(ethylene terephthalate) film having a thickness of 38 μm formed on both faces of the particle-containing photopolymerization-cured layer (layer A).

### Comparative Example 2

A particle-containing photopolymerizable composition layer (thickness: 50 μm) was prepared by coating the particle-containing photopolymerizable composition (A) on a biaxially oriented poly(ethylene terephthalate) film having a thickness of 38 μm, and a biaxially oriented poly(ethylene terephthalate) film having a thickness of 38 μm was bonded additionally to the particle-containing photopolymerizable composition layer, to give a laminate.

Then, the particle-containing photopolymerizable composition layer was photocured by irradiation of the laminate with ultraviolet ray (illuminance: 5 mW/cm²) for 3 minutes from a light source of a black light lamp 1 minute after preparation of the laminate, forming a particle-containing photopolymerization-cured layer, to give a sheet having a biaxially oriented poly(ethylene terephthalate) film having a thickness of 38 μm formed on both faces of the particle-containing photopolymerization-cured layer (layer A).

### Comparative Example 3

A particle-containing photopolymerizable composition layer (thickness: 100 μm) was prepared by coating the particle-containing photopolymerizable composition (B) on a biaxially oriented poly(ethylene terephthalate) film having a thickness of 38 μm, and a biaxially oriented poly(ethylene terephthalate) film having a thickness of 38 μm was bonded additionally to the particle-containing photopolymerizable composition layer, to give a laminate.

Then, the particle-containing photopolymerizable composition layer was photocured by irradiation of the laminate with ultraviolet ray (illuminance: 5 mW/cm²) for 3 minutes from a light source of a black light lamp 1 minute after preparation of the laminate, forming a particle-containing photopolymerization-cured layer, to give a sheet having a biaxially oriented poly(ethylene terephthalate) film having a thickness of 38 μm formed on both faces of the particle-containing photopolymerization-cured layer (layer A).

### Comparative Example 4

A particle-containing photopolymerizable composition layer (thickness: 100 μm) was prepared by coating the particle-containing photopolymerizable composition (A) on the area of the base material-supported monomer-absorptive sheet (B) where the monomer-absorptive layer was exposed by removal of the cover film, and a biaxially oriented poly(ethylene terephthalate) film having a thickness of 38 μm was bonded additionally to the particle-containing photopolymerizable composition layer, to give a laminate.

Then, a sheet was prepared by photocuring the laminate by irradiation thereof with ultraviolet ray (illuminance: 5 mW/cm²) for 3 minutes from a light source of a black light lamp 1 minute after preparation of the laminate.

### Comparative Example 5

A particle-containing photopolymerizable composition layer (thickness: 100 μm) was prepared by coating the particle-containing photopolymerizable composition (D) on a biaxially oriented poly(ethylene terephthalate) film having a thickness of 38 μm, and a biaxially oriented poly(ethylene terephthalate) film having a thickness of 38 μm was bonded additionally to the particle-containing photopolymerizable composition layer, to give a laminate.

Then, the particle-containing photopolymerizable composition layer was photocured by irradiation of the laminate with ultraviolet ray (illuminance: 5 mW/cm²) for 3 minutes from a light source of a black light lamp 1 minute after preparation of the laminate, forming a particle-containing photopolymerization-cured layer, to give a sheet having a biaxially oriented poly(ethylene terephthalate) film having a thickness of 38 μm formed on both faces of the particle-containing photopolymerization-cured layer (layer A).

### Comparative Example 6

A particle-containing photopolymerizable composition layer (thickness: 100 μm) was prepared by coating the particle-containing photopolymerizable composition (E) on a biaxially oriented poly(ethylene terephthalate) film having a thickness of 38 μm, and a biaxially oriented poly(ethylene terephthalate) film having a thickness of 38 μm was bonded additionally to the particle-containing photopolymerizable composition layer, to give a laminate.

Then, the particle-containing photopolymerizable composition layer was photocured by irradiation of the laminate with ultraviolet ray (illuminance: 5 mW/cm²) for 3 minutes from a light source of a black light lamp 1 minute after preparation of the laminate, forming a particle-containing photopolymerization-cured layer, to give a sheet having a biaxially oriented poly(ethylene terephthalate) film having a thickness of 38 μm formed on both faces of the particle-containing photopolymerization-cured layer (layer A).

### Comparative Example 7

A particle-containing photopolymerizable composition layer (thickness: 100 μm) was prepared by coating the particle-containing photopolymerizable composition (F) on a biaxially oriented poly(ethylene terephthalate) film having a thickness of 38 μm, and a biaxially oriented poly(ethylene terephthalate) film having a thickness of 38 μm was bonded additionally to the particle-containing photopolymerizable composition layer, to give a laminate.

Then, the particle-containing photopolymerizable composition layer was photocured by irradiation of the laminate with ultraviolet ray (illuminance: 5 mW/cm²) for 3 minutes from a light source of a black light lamp 1 minute after preparation of the laminate, forming a particle-containing photopolymerization-cured layer, to give a sheet having a biaxially oriented poly(ethylene terephthalate) film having a thickness of 38 μm formed on both faces of the particle-containing photopolymerization-cured layer (layer A).

### Comparative Example 8

A immiscible material-containing photopolymerizable composition layer (thickness: 100 μm) was prepared by coating the photopolymerizable sirup (E) on a biaxially oriented poly(ethylene terephthalate) film having a thickness of 38 μm, and a biaxially oriented poly(ethylene terephthalate) film having a thickness of 38 μm was bonded additionally to immiscible material-containing photopolymerizable composition layer, to give a laminate.

Then, immiscible material-containing photopolymerizable composition layer was photocured by irradiation of the laminate with ultraviolet ray (illuminance: 5 mW/cm²) for 3 minutes from a light source of a black light lamp 1 minute after preparation of the laminate, forming an immiscible material-containing photopolymerizable composition layer, to give a sheet having a biaxially oriented poly(ethylene terephthalate) film having a thickness of 38 μm formed on both faces of the immiscible material-containing photopolymerizable composition layer (layer A).

### Comparative Example 9

A immiscible material-containing photopolymerizable composition layer (thickness: 100 μm) was prepared by coating the photopolymerizable sirup (F) on a biaxially oriented poly(ethylene terephthalate) film having a thickness of 38 μm, and a biaxially oriented poly(ethylene terephthalate) film having a thickness of 38 μm was bonded additionally to immiscible material-containing photopolymerizable composition layer, to give a laminate.

Then, immiscible material-containing photopolymerizable composition layer was photocured by irradiation of the laminate with ultraviolet ray (illuminance: 5 mW/cm²) for 3 minutes from a light source of a black light lamp 1 minute after preparation of the laminate, forming an immiscible material-containing photopolymerizable composition layer, to give a sheet having a biaxially oriented poly(ethylene terephthalate) film having a thickness of 38 μm formed on both faces of the immiscible material-containing photopolymerizable composition layer (layer A).

### (Evaluation 1)

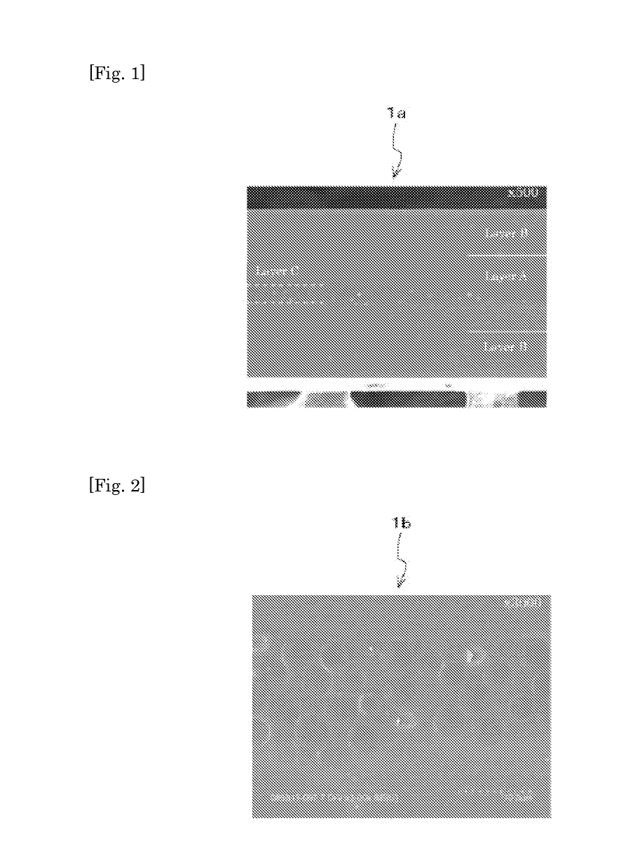

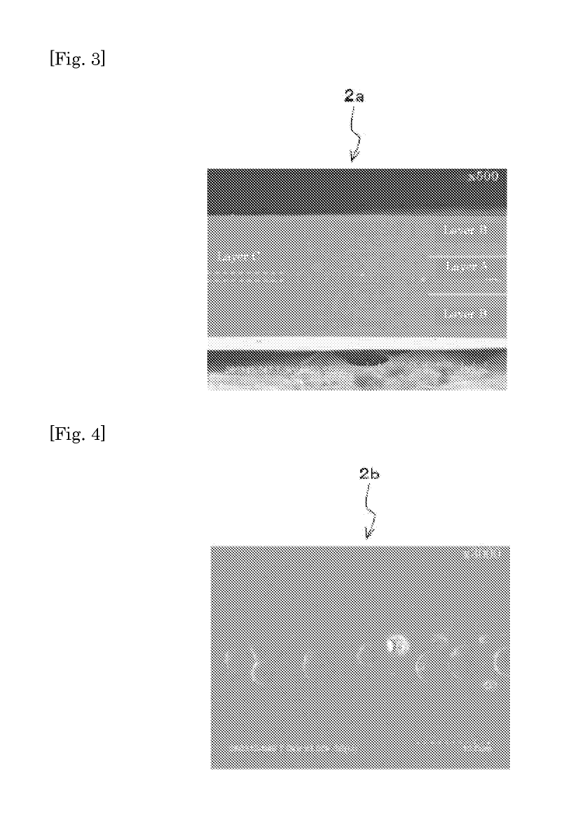

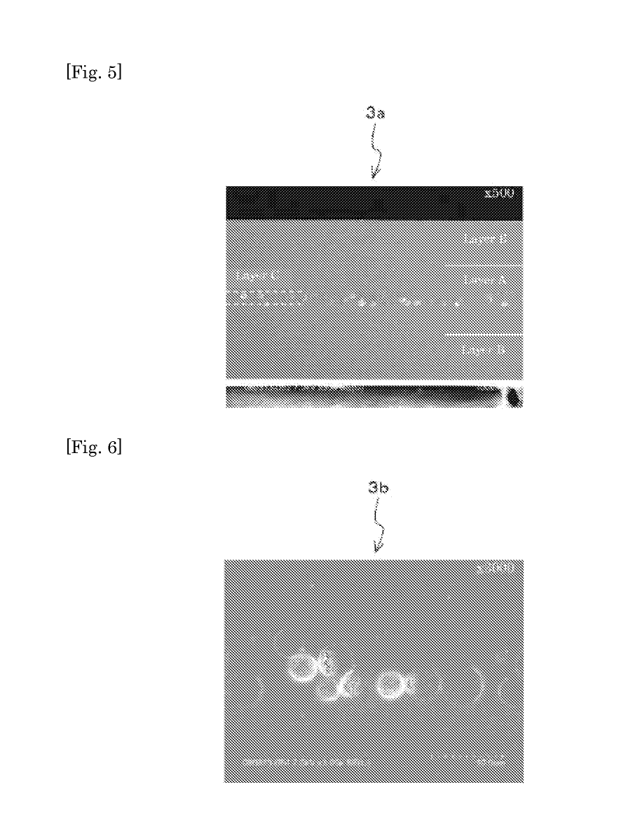

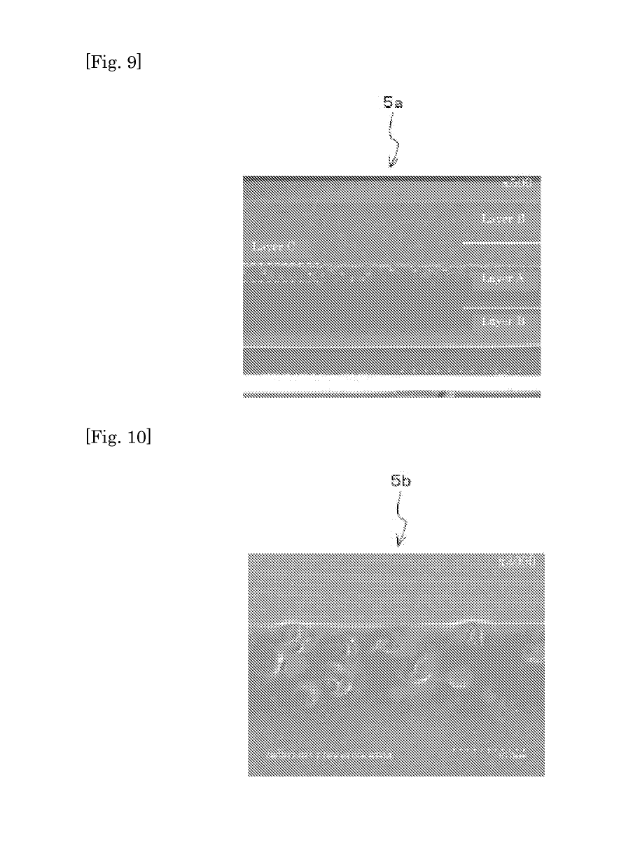

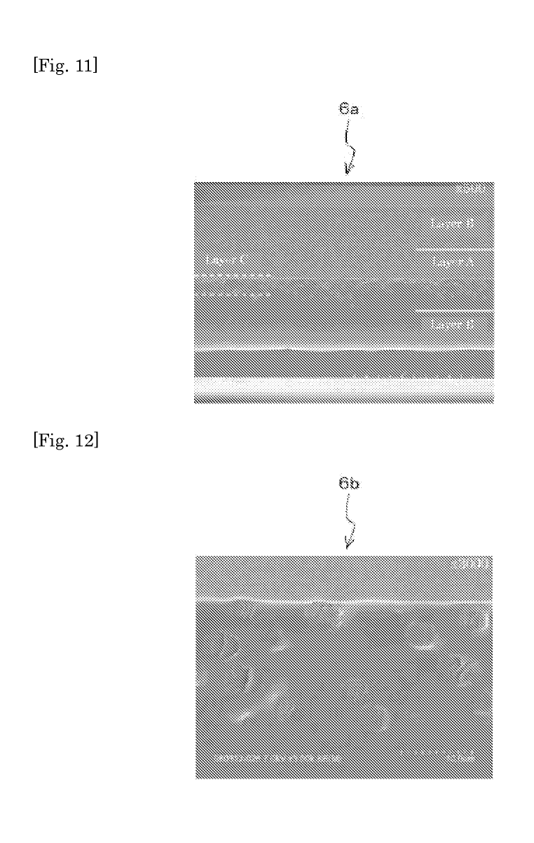

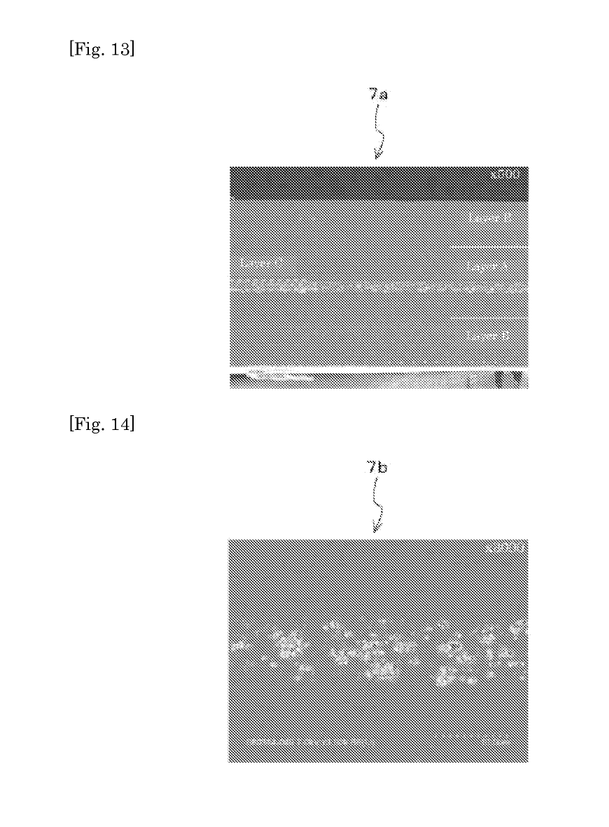

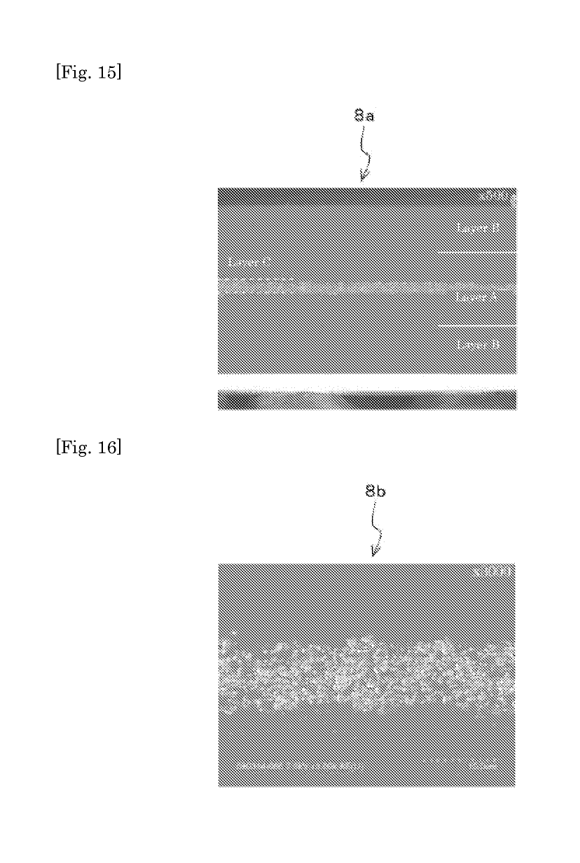

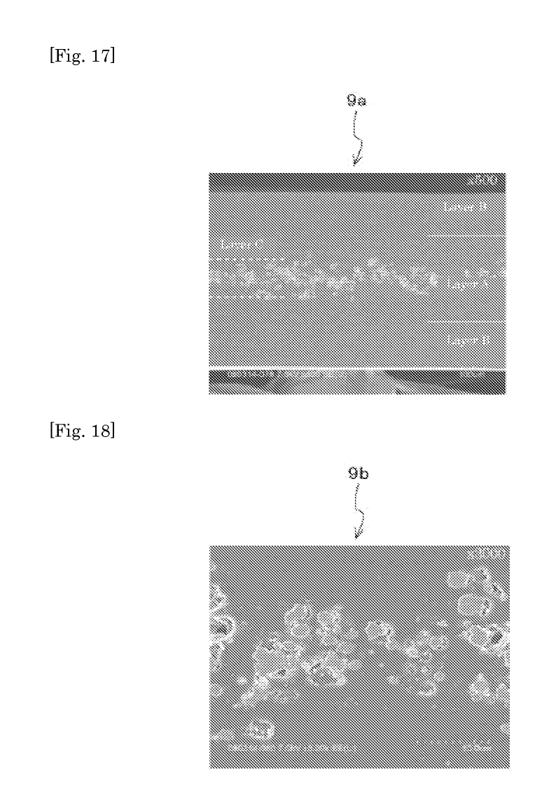

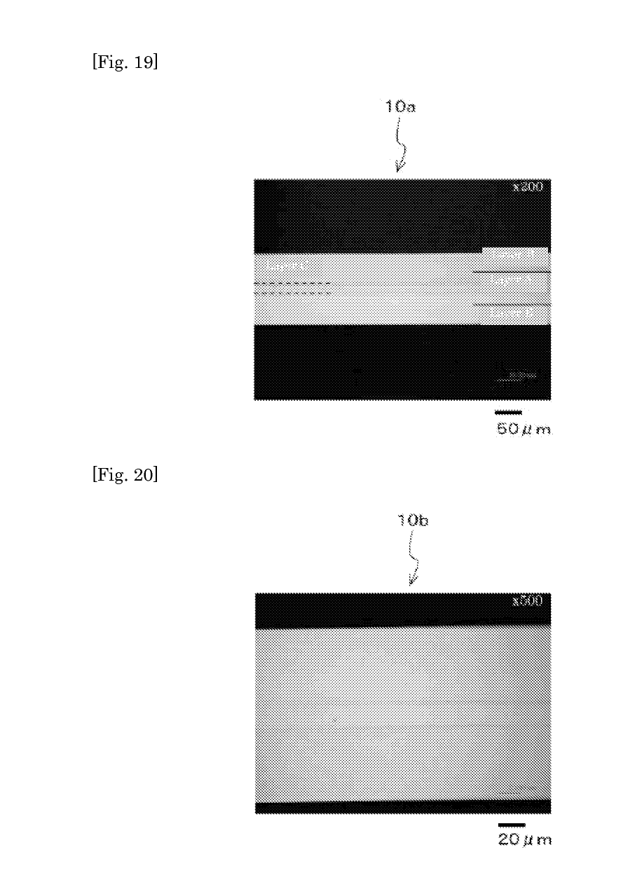

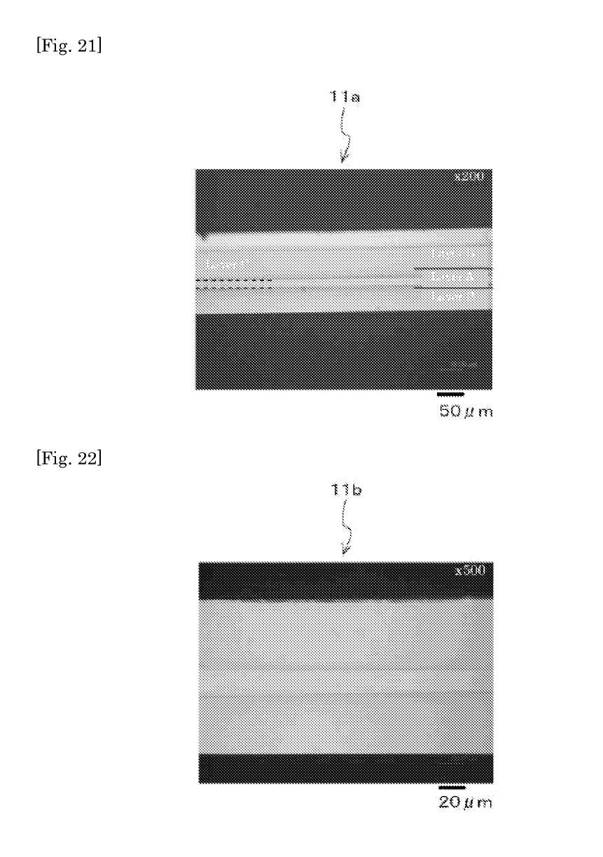

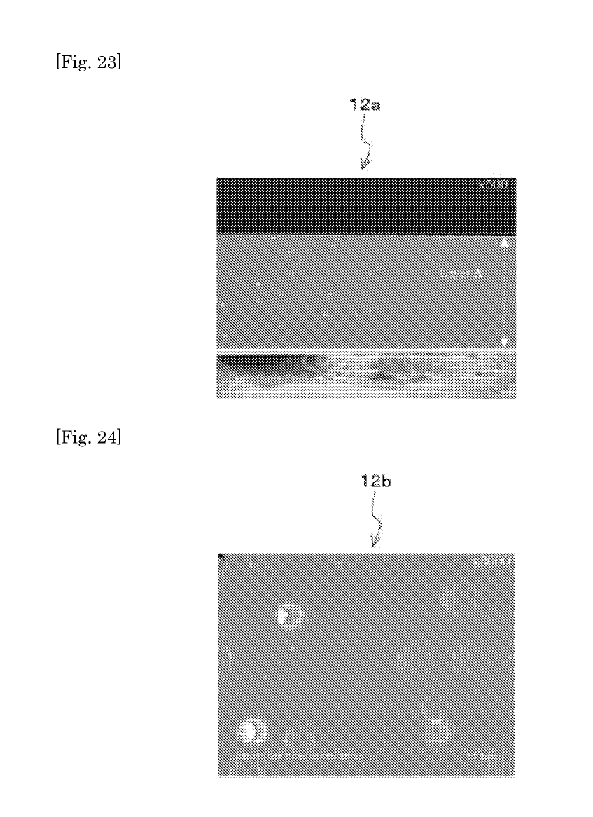

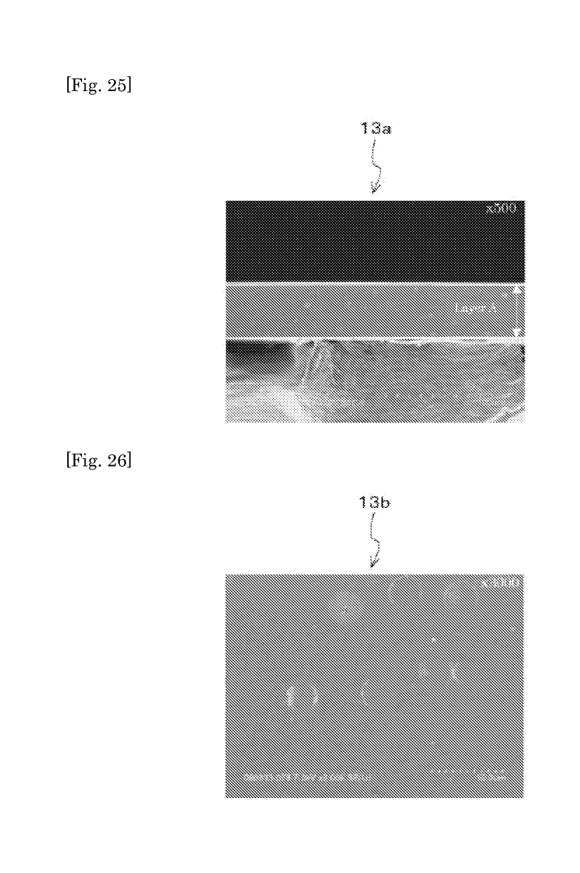

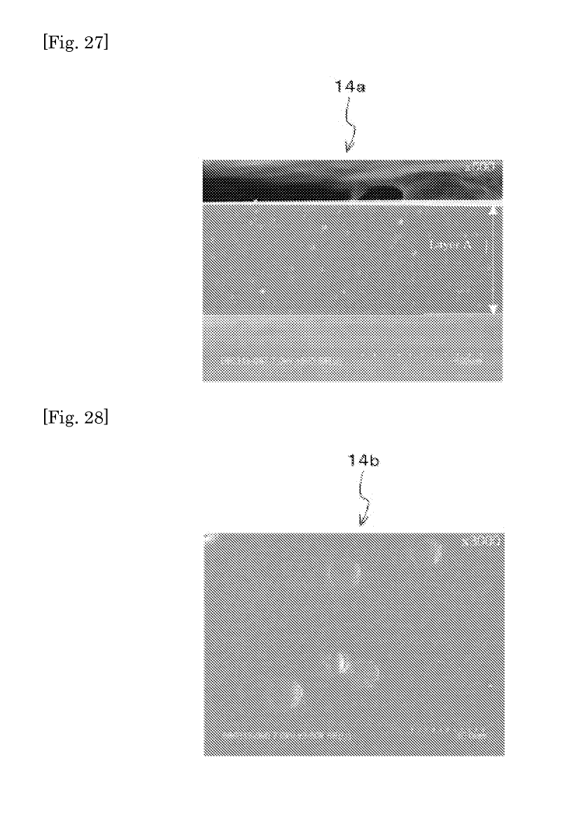

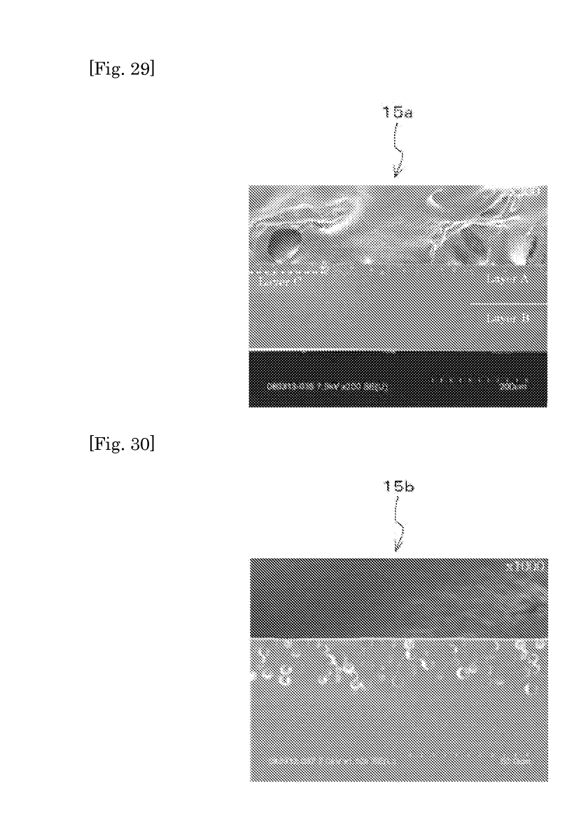

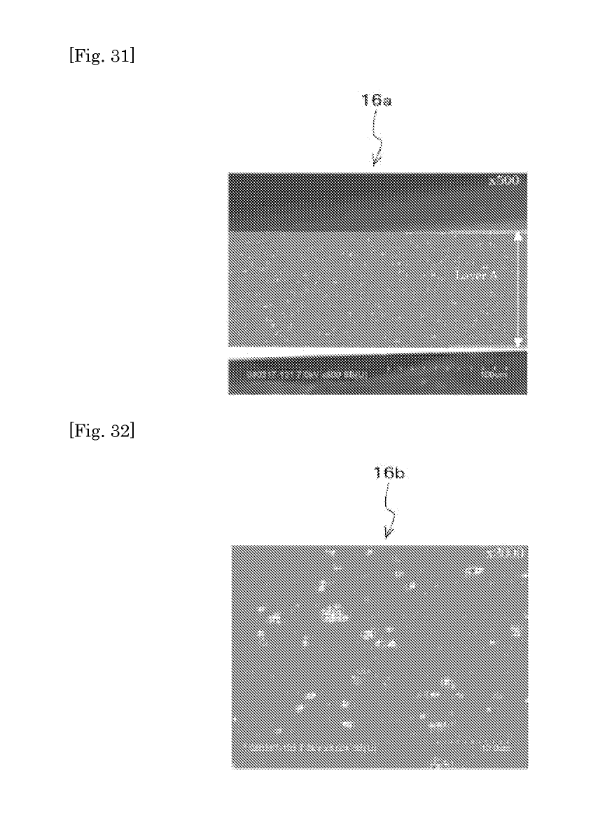

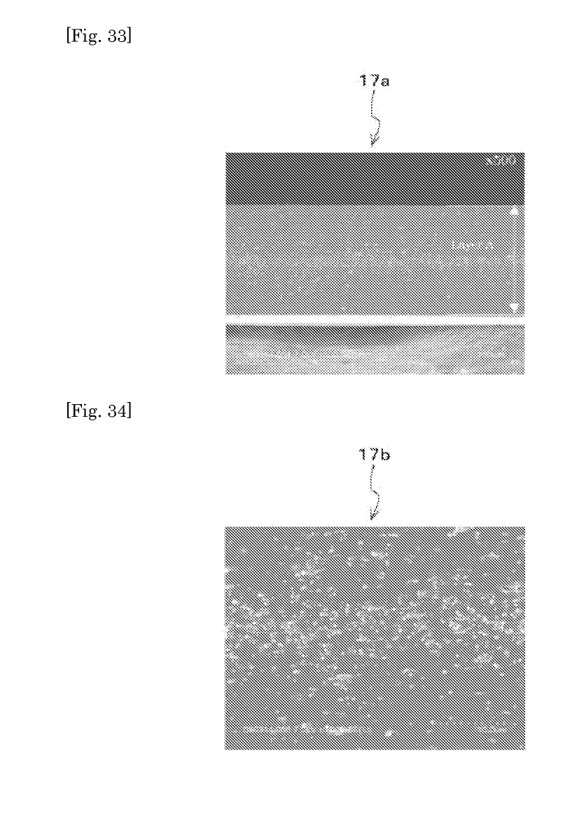

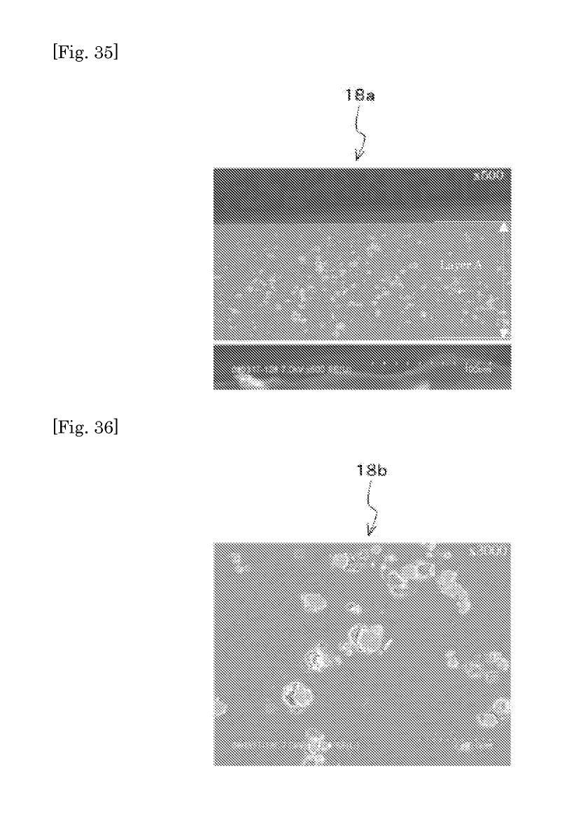

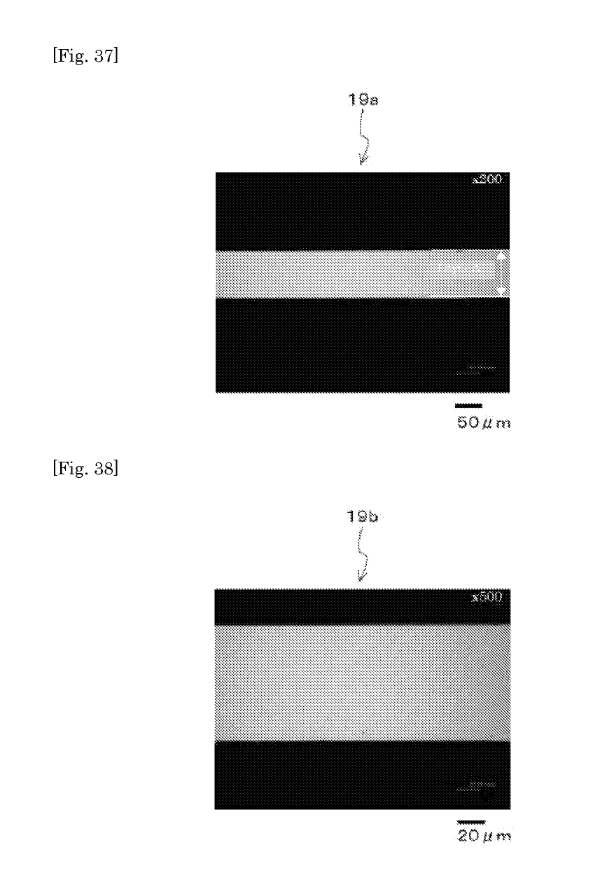

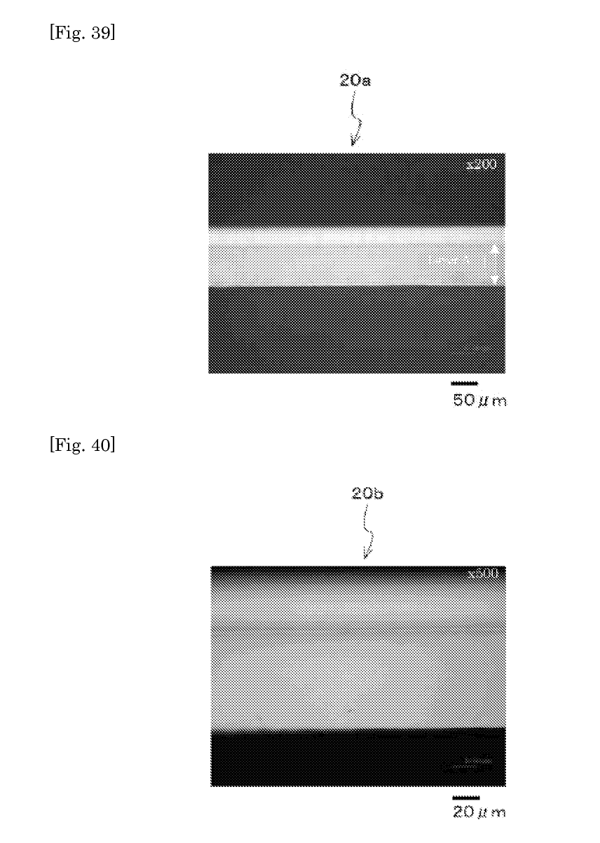

The cross section of each member (polymer sheet or sheet) was determined under a scanning electron microscope (SEM) (trade name: “S-4800”, manufactured by Hitachi High-Technologies Corporation) or an optical microscope (trade name: “OPTIPHOTO 2”, manufactured by NIKON CORPORATION) The scanning electron micrographs (SEM images) of the cross sections of the samples of Examples 1 to 9 and Comparative Examples 1 to 7 are shown respectively in FIGS. 1 to 18 and FIGS. 23 to 36, while the optical micrographs of the cross sections of the samples of Examples 10 and 11 and Comparative Examples 8 and 9 are shown respectively in FIGS. 19 to 22 and FIGS. 37 to 40.

Photographs with subscript a such as those 1a and 2a show the cross sections of the entire polymer sheet or the entire sheet, while photographs with subscript b such as those 1b and 2b show the cross sections of the regions close to the particle-enriched region (immiscible material-enriched region) (banded layer, coat layer) or any partial region of the sheet.

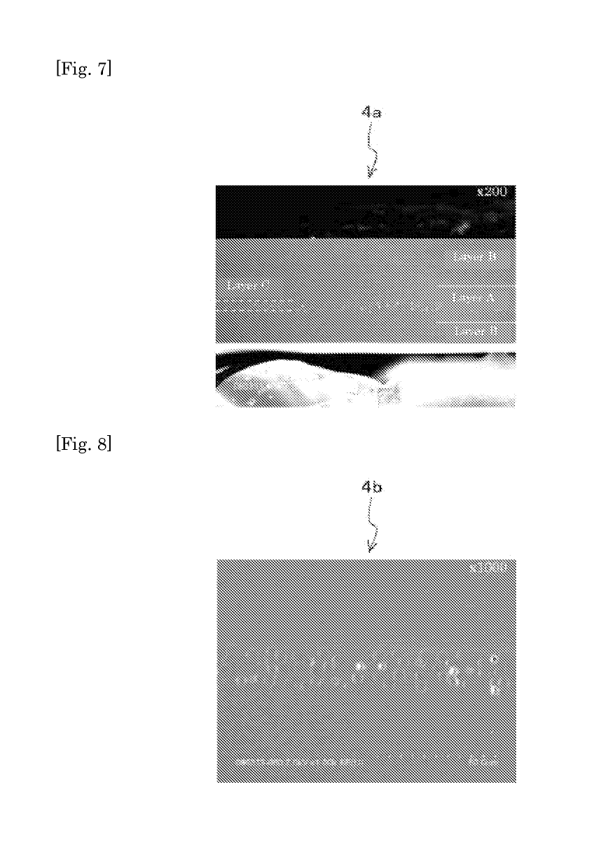

The magnification of the scanning electron micrograph of the cross section corresponding to the scanning electron micrograph with subscript a in each Figure is 200× in FIGS. 7(4a) and 29(15a) and 500× in other Figures. Alternatively, the magnification of the scanning electron micrograph of the cross section corresponding to the scanning electron micrograph with subscript b in each Figure is 1000× in FIGS. 8(4b) and 30(15b) and 3000× in other Figures. Yet alternatively, the magnification of the optical micrograph of the cross section corresponding to the optical micrograph with subscript a in each Figure is 200×. Yet alternatively, the magnification of the optical micrograph of the cross section corresponding to the optical micrograph with subscript b in each Figure is 500×.

The layer A in each Figure is a hypothetically shown layer containing particles and an immiscible material, which can be considered to be a polymer layer obtained from the immiscible material-containing photopolymerizable composition layer and the particle-containing photopolymerizable composition layer. Alternatively, the layer B is a hypothetically-shown monomer-absorptive layer in the sheet. Yet alternatively, the layer C, shows a layer region where the particles and the immiscible material are present (particle-enriched region, particle-banded region, immiscible material-enriched region, immiscible material-banded region), when particles or the immiscible material is distributed unevenly in the sheet.

### (Evaluation 2)

The thickness of layer A (thickness A), the thickness of monomer-absorptive layer of layer B (thickness B), and the thickness of layer C (thickness C) were determined by observation of the cross section of the member under the scanning electron microscope (SEM) or the optical microscope described above or by measurement of the thickness of the base material-supported monomer-absorptive sheet or the member by using a dial gauge with a scale of 1/1000. These values of thickness are summarized in the columns of thickness in Table 1. The segregation percentage and the occupancy of each article were determined respectively in accordance with “Method for Determining Segregation Percentage” and “Method for Determining Occupancy” described below, and the measured data are shown in the columns of “Segregation Percentage” and “Occupancy” in Table 1.

The thickness (thickness B) of the monomer-absorptive layer was determined by measuring the thickness of the base-material supported monomer-absorptive sheet (i.e., the total thickness of the base film, monomer-absorptive layer, and cover film) and subtracting the thickness of the base film and the thickness of the cover film from the total thickness of the base-material supported monomer-absorptive sheet.

The entire thickness (thickness of the laminated structure of layers B and A, thickness A+B) was determined by measuring the thickness of the sheet and subtracting the thickness of the base film in the base material-supported monomer-absorptive sheet from the thickness of the sheet.

The thickness of layer A (thickness A) was calculated by subtracting the thickness of the monomer-absorptive layer (thickness B) from the entire thickness (thickness A+B).

The thickness of layer A (thickness A) is not an observed value, but is a theoretical value.

The thickness of the layer region in which the particles or the immiscible material is distributed (layer C) in layer A was determined from the scanning electron micrograph of the cross section obtained under scanning electron microscope and the optical micrograph of the cross section obtained under optical microscope.

The thickness C is the average of the values determined from the scanning electron micrographs of the cross section obtained under scanning electron microscope and the optical micrographs of the cross section obtained under optical microscope.

### (Method for Determining Segregation Percentage)

The segregation percentage of the layer A was determined by calculation in accordance with the following equation:

Segregation percentage (%)=(1−C/A)×100

### (Method for Determining Occupancy)

The rate (occupancy) of the layer C (particle-enriched region, immiscible material-enriched region) in the entire thickness (thickness of the laminated structure of layers A and B, thickness A+B) in the height direction (in the thickness direction) was calculated in accordance with the following Formula:

Occupancy (%)=C/(A+B)×100

TABLE 1

| | Example | | | | | | | | | | |
|---|---|---|---|---|---|---|---|---|---|---|---|
| | 1 | 2 | 3 | 4 | 5 | 6 | 7 | 8 | 9 | 10 | 11 |
| Thickness of layer A | 65 | 26 | 60 | 72 | 57 | 65 | 62 | 62 | 75 | 62 | 33 |
| (thickness A) [μm] | | | | | | | | | | | |
| Thickness of layer B | 80 | 80 | 80 | 148 | 70 | 61 | 80 | 80 | 80 | 80 | 80 |
| (thickness B) [μm] | | | | | | | | | | | |
| Entire thickness | 145 | 106 | 140 | 220 | 127 | 126 | 142 | 142 | 155 | 142 | 113 |
| (A + B) [μm] | | | | | | | | | | | |
| Thickness of particle- | 11 | 5 | 5 | 10 | 8 | 15 | 8 | 8 | 25 | 22 | 15 |
| enriched region | | | | | | | | | | | |
| (immiscible material- | | | | | | | | | | | |
| enriched region) | | | | | | | | | | | |
| (thickness C) [μm] | | | | | | | | | | | |
| Segregation percentage [%} | 83 | 81 | 92 | 86 | 86 | 77 | 87 | 87 | 67 | 65 | 55 |
| Occupancy [%] | 8 | 5 | 4 | 5 | 6 | 12 | 6 | 6 | 15 | 15 | 13 |

| | Comparative Example | | | | | | | | |
|---|---|---|---|---|---|---|---|---|---|
| | 1 | 2 | 3 | 4 | 5 | 6 | 7 | 8 | 9 |
| Thickness of layer A | 95 | 43 | 95 | 87 | 100 | 64 | 100 | 100 | 100 |
| (thickness A) [μm] | | | | | | | | | |
| Thickness of layer B | 0 | 0 | 0 | 108 | 0 | 0 | 0 | 0 | 0 |
| (thickness B) [μm] | | | | | | | | | |
| Entire thickness | 95 | 43 | 95 | 195 | 100 | 64 | 100 | 100 | 100 |
| (A + B) [μm] | | | | | | | | | |
| Thickness of particle- | 95 | 43 | 95 | 20 | 100 | 94 | 100 | 100 | 100 |
| enriched region | | | | | | | | | |
| (immiscible material- | | | | | | | | | |
| enriched region) | | | | | | | | | |
| (thickness C) [μm] | | | | | | | | | |
| Segregation percentage [%} | 0 | 0 | 0 | 77 | 0 | 0 | 0 | 0 | 0 |
| Occupancy [%] | 100 | 100 | 100 | 10 | 100 | 100 | 100 | 100 | 100 |

The results obtained in evaluations 1 and 2 indicate that it is possible to obtain a member without distillative removal of the volatile components such as solvents.

Scanning micrographs and optical micrographs of the cross sections of the samples in Examples showed that the particles (immiscible material) in layer A are not present in the interface between layers A and B and in the region close thereto, but enriched in the layer A.

Alternatively, the results obtained in Comparative Examples confirmed that the particles (immiscible material) in layer A is not distributed unevenly but distributed as dispersed in the layer when a monomer-absorptive layer is not formed on both faces of the particle-containing photopolymerizable composition layer (immiscible material-containing photopolymerizable composition layer). It was also confirmed that the particles in layer A are enriched in the layer surface or in the region close thereto (interface in the opposite side of the interface with respect to layer B or the region close thereto), when a monomer-absorptive layer is formed only on one side of the particle-containing photopolymerizable composition layer (immiscible material-containing photopolymerizable composition layer).

Table 1 also confirms that the particles (immiscible material) are distributed unevenly in layer A, because the thickness of layer A is smaller than the thickness of layer C in Examples. On the other hand, it was also confirmed that, in Comparative Examples, the thickness of layer A is similar to the thickness of layer C and the particles are distributed as dispersed in the layer.

The segregation percentage is an indicator of the rate of layer C in layer A, and a segregation percentage of 0 means that the particles (immiscible material) do not have the unevenly distributed structure. Low segregation percentage (e.g., 0) may cause a problem of adhesion between layers A and B, possibly leading to layered exfoliation of the sheet or a problem in strength of layer A. The problem in strength of layer A has an adverse effect on the strength of the entire sheet. On the other hand, high segregation percentage leads to improved adhesion between layers A and B, because the particles (immiscible material) have an unevenly distributed structure in the region close to the center of layer A. Higher adhesion between layers A and B has a favorable influence on integration of the entire sheet and the strength of the entire sheet.

### INDUSTRIAL APPLICABILITY

The polymer member according to the present invention exhibits various properties, when the kind and amount of the immiscible material, the kind of the polymer in the polymer member, the thickness of the polymer member, and others are adjusted properly, and thus can be used in a wide variety of application fields. It can be used favorably, for example, as optical sheets, electronic circuits, power electronics materials, and adhesive tapes and also in medical applications.

### REFERENCE SIGNS LIST

1a Cross section of the polymer sheet of Example 1
1b Particle-enriched region in the cross section of the polymer sheet of Example 1
2a Cross section of the polymer sheet of Example 2
2b Particle-enriched region in the cross section of the polymer sheet of Example 2
3a Cross section of the polymer sheet of Example 3
3b Particle-enriched region in the cross section of the polymer sheet of Example 3
4a Cross section of the polymer sheet of Example 4
4b Particle-enriched region in the cross section of the polymer sheet of Example 4
5a Cross section of the polymer sheet of Example 5
5b Particle-enriched region in the cross section of the polymer sheet of Example 5
6a Cross section of the polymer sheet of Example 6
6b Particle-enriched region in the cross section of the polymer sheet of Example 6
7a Cross section of the polymer sheet of Example 7
7b Particle-enriched region in the cross section of the polymer sheet of Example 7
8a Cross section of the polymer sheet of Example 8
8b Particle-enriched region in the cross section of the polymer sheet of Example 8
9a Cross section of the polymer sheet of Example 9
9b Particle-enriched region in the cross section of the polymer sheet of Example 9
10a Cross section of the polymer sheet of Example 10
10b Immiscible materia-enriched region in the cross section of the polymer sheet of Example 10
11a Cross section of the polymer sheet of Example 11
11b Immiscible material-enriched region in the cross section of the polymer sheet of Example 11
12a Cross section of the sheet of Comparative Example 1
12b Particle-containing photopolymerization-cured layer in the cross section of the sheet of Comparative Example 1
13a Cross section of the sheet of Comparative Example 2
13b Particle-containing photopolymerization-cured layer in the cross section of the sheet of Comparative Example 2
14a Cross section of the sheet of Comparative Example 3
14b Particle-containing photopolymerization-cured layer in the cross section of the sheet of Comparative Example 3
15a Cross section of the sheet of Comparative Example 4
15b Particle-enriched region in the cross section of the sheet of Comparative Example 4
16a Cross section of the sheet of Comparative Example 5
16b Particle-containing photopolymerization-cured layer in the cross section of the sheet of Comparative Example 5
17a Cross section of the sheet of Comparative Example 6
17b Particle-containing photopolymerization-cured layer in the cross section of the sheet of Comparative Example 6
18a Cross section of the sheet of Comparative Example 7
18b Particle-containing photopolymerization-cured layer in the cross section of the polymer sheet of Comparative Example 7
19a Cross section of the sheet of Comparative Example 8
19b Immiscible material-containing photopolymerization-cured layer in the cross section of the sheet of Comparative Example 8
20a Cross section of the sheet of Comparative Example 9
20b Immiscible material-containing photopolymerization-cured layer in the cross section of the sheet of Comparative Example 9

1. A process for producing a polymer member, comprising forming a monomer-absorptive layer that can absorb a polymerizable monomer on both faces of an immiscible material-containing polymerizable composition layer containing a substance incompatible with the polymer obtained by polymerization of the polymerizable monomer and giving, by polymerization of the laminate, a polymer member having an unevenly distributed structure in which the immiscible material is not present at the interface between the immiscible material-containing polymerizable composition layer and the monomer-absorptive layers immediately after lamination.

2. The process for producing a polymer member according to claim 1, wherein the monomer-absorptive layer is a polymeric monomer-absorptive polymer layer.

3. The process for producing a polymer member according to claim 2, wherein at least one monomer component constituting the polymer in the monomer-absorptive polymer layer is identical with at least one of the polymerizable monomers constituting the immiscible material-containing polymerizable composition layer.

4. The process for producing a polymer member according to claim 1, wherein the monomer-absorptive layer is a pressure-sensitive adhesive composition layer.

5. The process for producing a polymer member according to claim 1, wherein active energy ray irradiation is used during the polymerization.

6. The process for producing a polymer member according to claim 1, wherein the immiscible material is particles.

7. The process for producing a polymer member according to claim 1, wherein the immiscible material is a polymer.

8. The process for producing a polymer member according to claim 1, wherein the polymerizable monomer is an acrylic monomer.

9. The process for producing a polymer member according to claim 1, wherein the polymer member is in a shape of tape or sheet.

10. A polymer member, characterized by being prepared by the process for producing a polymer member according to claim 1.
